(19) United States
(12) Patent Application Publication
(10) Pub. No.: US 2026/0243973 A1
(43) Pub. Date: Aug. 20, 2026

(54) OPTICAL DEVICE, LIGHT SOURCE MODULE AND MANUFACTURING METHOD THEREOF, OPTICAL ENGINE, AND XR GLASSES

(71) Applicant: TDK Corporation, Tokyo (JP)

(72) Inventors: Hiroki HARA, Tokyo (JP); Yasuhiro TAKAGI, Tokyo (JP); Atsushi SHIMURA, Tokyo (JP)

(73) Assignee: TDK Corporation, Tokyo (JP)

(21) Appl. No.: 19/535,146

(22) Filed: Feb. 10, 2026

(30) Foreign Application Priority Data
Feb. 17, 2025 (JP) 2025-023361

(51) Int. Cl. G02B 6/42; G02B 27/01

(52) U.S. Cl. CPC G02B 6/421; G02B 27/0172; G02B 2027/0178

(57) ABSTRACT

Provided is an optical device to stably obtain a sufficient amount of monitoring light. An optical device 10A of one aspect includes an optical function layer on a substrate. The optical function layer includes optical branching portions 120a, 120b, 120c that branch the visible light emitted from the corresponding visible laser light sources 301a, 301b, 301c, monitor optical waveguides 130a, 130b, 130c connected to one of the output portion of the corresponding optical branching portions, and modulation optical waveguides 140a, 140b, 140c connected to the other of the output portion of the corresponding optical branching portions. The monitoring light propagating through the monitor optical waveguides is emitted from the monitor ports 131a, 131b, 131c. The display light propagating through the modulation optical waveguides is modulated by the optical modulation portions 170a, 170b, 170c, and then multiplexed by the optical multiplexing portion 180 to output from the optical output port 191.

### CROSS-REFERENCE TO RELATED APPLICATION

This application claims a priority, under the Paris Convention, to Japanese Patent Application No. 2025-23361 filed on February 17, 2025, the entirety of which is incorporated herein by reference.

### TECHNICAL FIELD

The present disclosure relates to an optical device, a light source module and manufacturing method thereof, an optical engine, and XR glasses.

### BACKGROUND

In recent years, XR glasses such as AR (Augmented Reality) glasses and VR (Virtual Reality) glasses have attracted attention as small wearable devices. In XR glasses, it is important to miniaturize each component so as to be accommodated in a normal eyeglass size. In particular, retinal scanning displays that allow users to view images by forming an image of two-dimensionally scanned light on the user's retina are expected. In this retinal scanning display, light sources such as LEDs (Light Emitting Diodes) and LDs (Laser Diodes) that correspond to the colors R (red), G (green), and B (blue) are generally used. The visible light of each color emitted from each light source is multiplexed and transmitted to the image display portion. The image display portion scans the transmitted light two-dimensionally and makes it incident on the user's pupil. This incident light forms an image on the user's retina, and the user visually recognizes the image.

Color expression in XR glasses and the like is realized by using the visible light of each color of RGB. When adjusting the color balance of each color of RGB, the incident light corresponding to each color is branched, and the branched light is monitored as monitoring light. The color balance of each color can be adjusted by checking the light intensity of the monitoring light.

Japanese Patent publication No. 2024-94959 discloses an optical multiplexing portion that can be connected to or integrated with an optical modulator using a lithium niobate film and can adjust the color balance of RGB. The optical multiplexing portion disclosed in Japanese Patent Application publication No. 2024-94959 has multiple multimode interference type optical multiplexing portions (first to third optical multiplexing portions), and visible light modulated by a Mach-Zehnder type optical modulator is input to each optical multiplexing portion. The first optical multiplexing portion is connected to the first optical input side optical waveguide, the first monitoring light output side optical waveguide, and the first connecting optical waveguide. The second optical multiplexing portion is connected to the second optical input side optical waveguide, the first connecting optical waveguide, the second monitoring light output side optical waveguide, and the second connecting optical waveguide. The third optical multiplexing portion is connected to the third optical input side optical waveguide, the second connecting optical waveguide, the third monitoring light output side optical waveguide, and the optical output port connecting optical waveguide. The first to third monitoring light output side optical waveguides are all arranged so as not to intersect with the other optical waveguides, and are structured to prevent loss of optical output (crossing loss).

The optical multiplexing portion disclosed in Japanese Patent Application publication No. 2024-94959 is configured with an optical multiplexing portion connected to the rear stage of a Mach-Zehnder type optical modulator. The visible light modulated by the optical modulator is split in the optical multiplexing portion and output from the monitoring light output port (monitor port) through the monitoring light output side optical waveguide.

As recognized by the present inventors, however, in order to obtain a sufficient amount of monitoring light from the monitoring light output port, it is necessary to increase the intensity of the visible light modulated by the optical modulator. If the light intensity is insufficient, a sufficient amount of light cannot be obtained from the monitoring light output port, thereby causing a problem which has an effect on measurement accuracy.

As also recognized by the present inventors, when a Mach-Zehnder type optical modulator is used, the light intensity may possibly decrease due to the initial phase difference generated between the two optical waveguides. This phase difference depends on the initial setting when no voltage is applied, and it is necessary to apply an appropriate voltage to ensure sufficient light intensity. In particular, when a visible laser light source is input to the light input port and active alignment is performed using light from the monitoring light output port, it is necessary to apply an appropriate voltage to each optical modulator through which each visible light propagates. This causes a problem that the work related to active alignment becomes complicated, thereby resulting in decreasing the work efficiency.

### SUMMARY

One aspect of the present disclosure provides an optical device comprising: a substrate; and an optical function layer formed on a main surface of the substrate, wherein the optical function layer comprises: optical input ports respectively corresponding to a plurality of visible laser light sources and capable of receiving visible light emitted from the corresponding visible laser light source; input optical waveguides respectively connected to the optical input ports; optical branching portions respectively having an input portion connected to each input optical waveguide and two output portions; monitor optical waveguides respectively connected to one of the output portions of each optical branching portion; monitor ports respectively connected to the monitor optical waveguides and emitting monitoring light to the outside; first optical waveguides respectively connected to the other of the output portions of each optical branching portion; optical modulation portions respectively connected to the first optical waveguides; second optical waveguides respectively connected to the optical modulation portions; an optical multiplexing portion connected to the second optical waveguides; an output optical waveguide connected to the optical multiplexing portion; and an optical output port connected to the output optical waveguide and emitting light multiplexed by the optical multiplexing portion to the outside.

One aspect of the present disclosure provides a light source module comprising the above optical device and the plurality of visible laser light sources.

One aspect of the present disclosure provides a method for manufacturing the light source module according to claim 11, comprising: directing visible light emitted from the visible laser light source into the light input port; directing output light emitted from the monitor port into an optical detection device; adjusting a relative position of the visible laser light source with respect to the optical device, based on a detection result of the optical detection device; and fixing the visible laser light source to the optical device at a position where an optical axis of the visible light emitted from the visible laser light source coincides with a center position of the light input port.

One aspect of the present disclosure provides an optical engine comprising the above light source module; and an optical scanning mirror that reflects the light emitted from the light source module at a different angle so as to display an image.

One aspect of the present disclosure provides XR glasses comprising the above optical engine.

### BRIEF DESCRIPTION OF DRAWINGS

FIG. 1 is a schematic plan view of a light source module in a first embodiment of the present disclosure.

FIG. 2 is a schematic plan view showing the state in which the electrodes and pads have been removed from the light source module in FIG. 1.

FIG. 3 is a cross-sectional view taken along line A-A in FIG. 1.

FIG. 4 is a cross-sectional view taken along line B-B in FIG. 1.

FIG. 5 is a cross-sectional view taken along line C-C in FIG. 1.

FIG. 6 is a schematic plan view of the tapered portion in FIG. 1 and FIG. 2.

FIG. 7 is a schematic plan view of the crossing waveguide in FIG. 1 and FIG. 2.

FIG. 8 is a schematic plan view of the connected crossing waveguides in FIG. 1 and FIG. 2.

FIG. 9 is a schematic plan view of the high-order mode filter in FIG. 1 and FIG. 2.

FIG. 10 is a diagram for explaining active alignment performed in the manufacturing process of the light source module in the first embodiment of the present disclosure.

FIG. 11 is a diagram for explaining the concept of active alignment performed in the first embodiment of the present disclosure.

FIG. 12 is a diagram for explaining the state in which an anti-reflection device is disposed in the vicinity of the monitor port of the light source module in the first embodiment of the present disclosure.

FIG. 13 is a conceptual diagram of the optical engine and XR glasses in the first embodiment of the present disclosure.

FIG. 14 is a schematic plan view of a light source module in a derivative example of the first embodiment of the present disclosure.

FIG. 15 is a schematic plan view showing the state in which the electrodes and pads have been removed from the light source module in FIG. 14.

FIG. 16 is a schematic plan view of a light source module in the second embodiment of the present disclosure.

FIG. 17 is a schematic plan view showing the state where the electrodes and pads have been removed from the light source module in FIG. 16.

FIG. 18 is a schematic plan view of a light source module in a derivative example of the second embodiment of the present disclosure.

FIG. 19 is a schematic plan view showing the state where the electrodes and pads have been removed from the light source module in FIG. 18.

FIG. 20 is a schematic plan view of a light source module in a third embodiment of the present disclosure.

FIG. 21 is a schematic plan view showing the state where the electrodes and pads have been removed from the light source module in FIG. 20.

FIG. 22 is a schematic plan view of a light source module in a fourth embodiment of the present disclosure.

FIG. 23 is a schematic plan view showing the state where the electrodes and pads have been removed from the light source module in FIG. 22.

### DETAILED DESCRIPTION

One aspect of the present disclosure provides an optical device, a light source module and its manufacturing method, an optical engine, and XR glasses that can stably obtain a sufficient amount of monitoring light from a monitor port.

Embodiments of the present disclosure will be described in detail hereinafter with reference to the drawings as appropriate. In the drawings used in the following description, the characteristic parts may be enlarged for the sake of convenience in order to make the features easier to understand, and the dimensions and ratios of each component may differ from the actual ones. The materials, dimensions, etc. exemplified in the following description are merely examples. The present disclosure is not limited to these examples, and can be modified as appropriate within the scope of the effects of the present disclosure. In addition, "~" indicating a numerical range means any numerical value within the range including the numerical values written before and after it as the lower and upper limits.

### First embodiment

The first embodiment of the present disclosure will be described hereinafter.

### Light source module

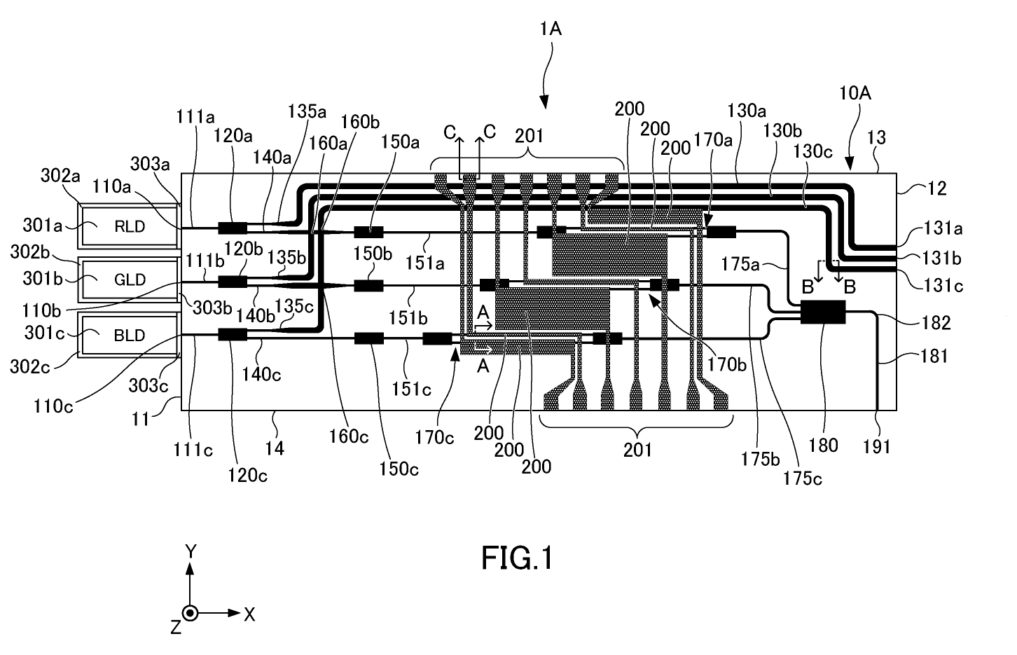

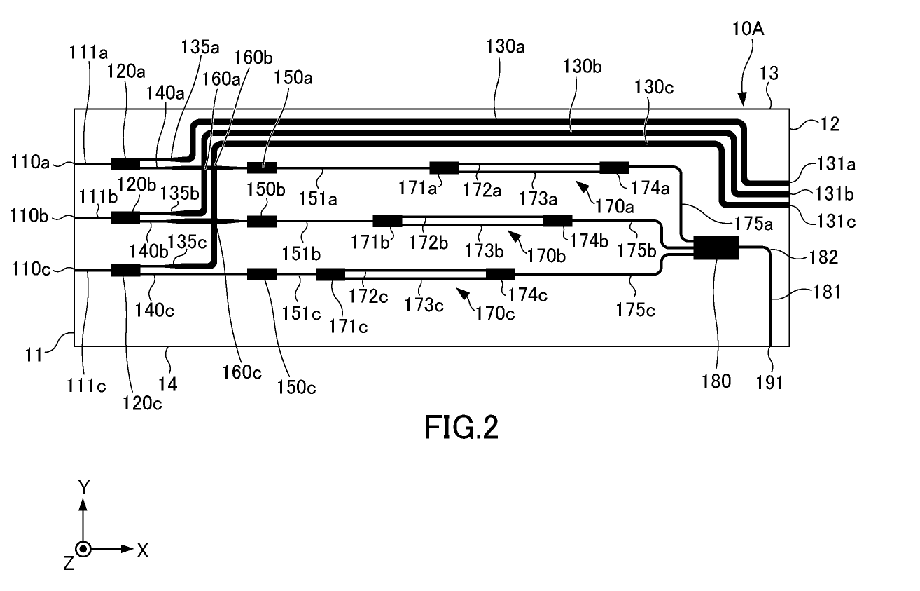

The configuration of the light source module 1A in the first embodiment of the present disclosure will be described with reference to FIGS. 1 and 2. FIG. 1 is a schematic plan view of the light source module 1A in the first embodiment. FIG. 2 is a schematic plan view showing the state in which the electrode 200 and the pad portion 201 have been removed from the light source module 1A in FIG. 1.

As shown in FIG. 1 and FIG. 2, the light source module 1A has multiple visible laser light sources 301a, 301b, and 301c, and an optical device 10A.

In this specification, in the XYZ Cartesian coordinate system set in the drawings, the direction along one side of the optical device 10A is the X direction, the direction perpendicular to the X direction is the Y direction, and the direction perpendicular to the X and Y directions is the Z direction. The X direction coincides with the direction of light incidence from the multiple visible laser light sources 301a, 301b, and 301c to the optical device 10A. The Y direction is the width direction of the optical device 10A. The Z direction is a direction perpendicular to the main surface of the optical device 10A. In the following, the directions are further taken into consideration and expressed as "positive Z direction" and "negative Z direction", etc., and in particular the "positive Z direction" may be referred to as the upward direction and the "negative Z direction" as the downward direction. Note that the Z direction, which is the up-down direction, does not necessarily coincide with the direction in which gravity acts.

### Visible Laser Light Source

The multiple visible laser light sources 301a, 301b, and 301c are configured to emit visible light (laser light) in different wavelength ranges, for example. The visible laser light source 301a is a light source that emits laser light of a specific color, and is not particularly limited, but for example, a laser diode (LD) or a laser light emitting diode can be used.

The visible laser light sources 301a, 301b, and 301c each emit visible light of the three primary colors (red, green, and blue). By superimposing these emitted lights based on the principle of additive color mixing, a desired color can be expressed. The visible laser light sources 301a, 301b, and 301c may emit light of a color other than the three primary colors.

In the light source module 1A, the visible laser light source 301a emits red light, the visible laser light source 301b emits green light, and the visible laser light source 301c emits blue light. The visible laser light source 301a is, for example, a red laser light source that emits laser light (red light) in a wavelength range of 590 nm ~ 800 nm. The visible laser light source 301b is, for example, a green laser light source that emits laser light (green light) in a wavelength range of 490 nm or more and less than 590 nm. The visible laser light source 301c is, for example, a blue laser light source that emits laser light (blue light) in a wavelength range of 380 nm or more and less than 490 nm. There is no particular restriction on the order or number of the visible laser light sources 301a, 301b, and 301c that emit light in each wavelength range.

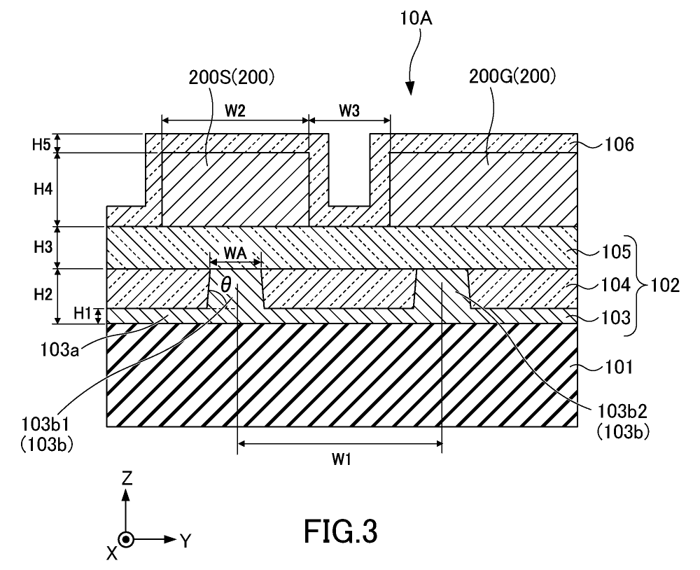

The multiple visible laser light sources 301a, 301b, and 301c are each fixed to the optical device 10A. The visible laser light sources 301a, 301b, and 301c may be mounted on the upper surfaces of the subcarriers 302a, 302b, and 302c, for example, in the form of bare chips. In this case, the subcarriers 302a, 302b, and 302c are joined to the substrate 101 of the optical device 10A (see FIGS. 3 to 5) through junction portions 303a, 303b, and 303c such as metal joint layers.

In order to properly input the laser light emitted by the visible laser light sources 301a, 301b, and 301c to the optical input ports 110a, 110b, and 110c of the optical device 10A, it is necessary to adjust the optical axis. In the light source module 1A shown in FIG. 1, the optical axes of the visible laser light sources 301a, 301b, and 301c can be adjusted based on the monitoring light emitted from the monitor ports 131a, 131b, and 131c, as described later.

### Optical Device

The optical device 10A has a flat plate structure in which an optical waveguide is formed two-dimensionally on the substrate 101. As shown in FIG. 1 and FIG. 2, the optical device 10A has four end faces located on the side, that is, a first end face 11, a second end face 12, a third end face 13, and a fourth end face 14.

The first end face 11 is a light incidence surface on which the optical input ports 110a, 110b, and 110c are arranged. The second end face 12 is a surface that is approximately parallel to the first end face 11 and is located on the opposite side of the first end face 11. In the optical device 10A shown in FIGS. 1 and 2, monitor ports 131a, 131b, and 131c are disposed on the second end face 12. The third end face 13 is a surface that is substantially perpendicular to the first end face 11 and the second end face 12, and is located on the left side (positive Y direction side) as viewed from the first end face 11. The fourth end face 14 is a surface that is substantially perpendicular to the first end face 11 and the second end face 12, and is located on the right side (negative Y direction side) as viewed from the first end face 11. In the optical device 10A shown in FIGS. 1 and 2, an optical output port 191 is disposed on the fourth end face 14.

The optical device 10A has an optical waveguide that propagates light. The optical waveguide of the optical device 10A is designed to propagate the laser light emitted from the visible laser light sources 301a, 301b, and 301c, and to emit the laser light from the monitor ports 131a, 131b, and 131c and the optical output port 191.

As shown in FIG. 1, an electrode 200 is disposed on the upper surface (main surface) of the optical device 10A. The electrode 200 is used to apply a drive voltage for modulating light, and is appropriately disposed in the vicinity of the optical modulation portions 170a, 170b, and 170c. The electrode 200 has a pad portion 201 in the vicinity of the third end face 13 and the fourth end face 14. The pad portion 201 functions as a connection terminal for electrically connecting a voltage supply circuit. The structure of the electrode 200 is not particularly limited. Although not shown, an electrode for applying a bias voltage may be arranged.

The configuration of the optical device 10A in this embodiment will be described hereinafter.

The optical waveguide that propagates the laser light emitted from the visible laser light source 301a will be described. An optical input port 110a is arranged on the first end face 11. The optical input port 110a is an optical input port for the laser light emitted from the visible laser light source 301a. The laser light emitted from the visible laser light source 301a is incident on the optical input port 110a.

An input optical waveguide 111a is connected to the optical input port 110a. One end of the input optical waveguide 111a is connected to the optical input port 110a. The other end of the input optical waveguide 111a is connected to the optical input portion of the optical branching portion 120a.

The optical branching portion 120a has a one-input, two-output structure equipped with one optical input portion and two optical output portions, and is configured to branch a single optical input signal into two optical output signals. The optical branching portion 120a is not particularly limited as long as it splits the light propagating through the optical waveguide, and for example, an MMI coupler (multimode interference coupler), a Y-branch (Y-shaped waveguide), a directional coupler, etc. can be used.

One optical output portion of the optical branching portion 120a is connected to one end of the monitor optical waveguide 130a. The monitor optical waveguide 130a bends midway and extends in the Y direction, and extends in the X direction in the vicinity of the third end face 13. The other end of the monitor optical waveguide 130a is connected to a monitor port 131a disposed on the second end face 12. The monitor port 131a is a monitoring light output port used when monitoring the laser light emitted from the visible laser light source 301a. In this specification, the light output from the optical branching portion 120a to the monitor optical waveguide 130a may be referred to as monitoring light.

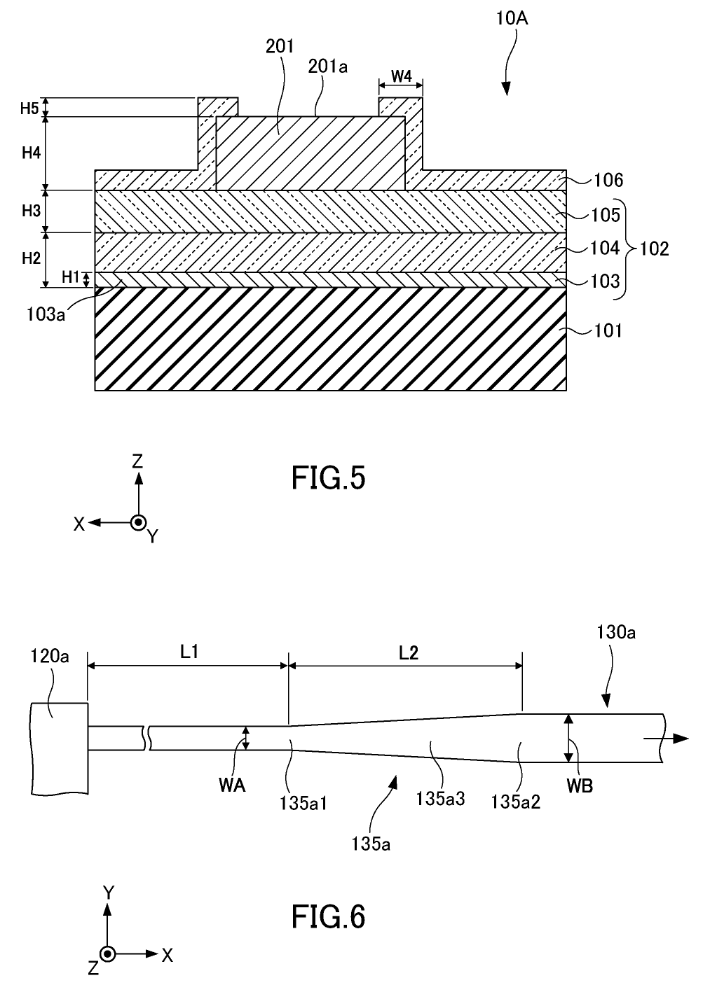

A tapered portion 135a that changes the width of the optical waveguide (waveguide width) is disposed in the middle of the monitor optical waveguide 130a. The tapered portion 135a will be described later with reference to FIG. 6.

The other optical output portion of the optical branching portion 120a is connected to one end of the modulation optical waveguide 140a. The other end of the modulation optical waveguide 140a is connected to the optical input portion of the high-order mode filter 150a. In this specification, the light output from the optical branching portion 120a to the modulation optical waveguide 140a may be referred to as display light. The display light output from the optical branching portion 120a is red light, which is modulated by the optical modulation portion 170a and then multiplexed with display light of other wavelengths to be used, for example, as image projection light for XR glasses.

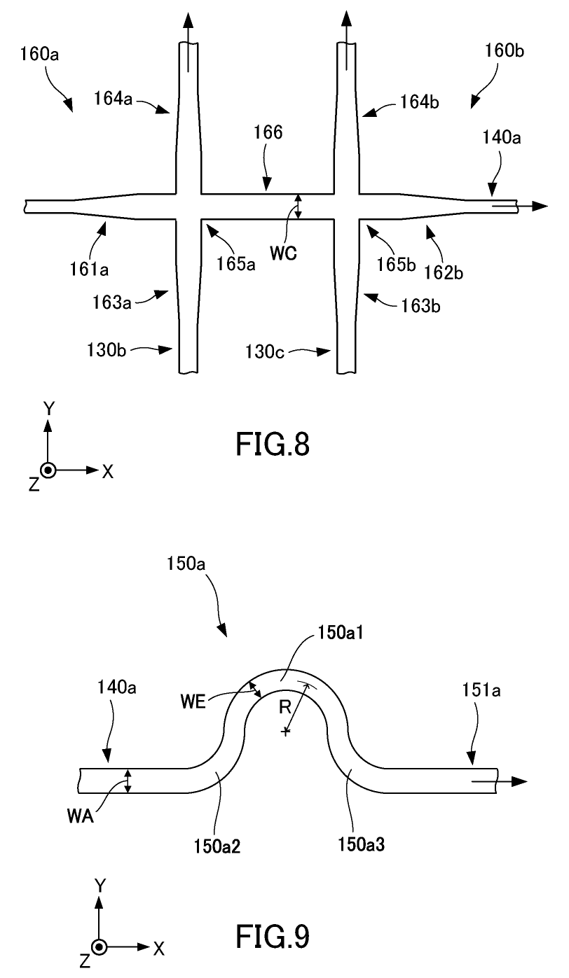

In the modulation optical waveguide 140a, a crossing waveguide 160a that crosses the monitor optical waveguide 130b and a crossing waveguide 160b that crosses the monitor optical waveguide 130c are arranged. The crossing waveguides 160a and 160b will be described later with reference to FIG. 8.

The high-order mode filter 150a has an optical input portion and an optical output portion, and is configured to remove the higher modes of the light input to the optical input portion and to output only single mode light from the optical output portion. The high-order mode filter 150a will be described later with reference to FIG. 9.

The optical output portion of the high-order mode filter 150a is connected to one end of the modulation optical waveguide 151a. The other end of the modulation optical waveguide 151a is connected to the optical input portion of the optical modulation portion 170a. The modulation optical waveguide 140a and the modulation optical waveguide 151a constitute the first optical waveguide of the present disclosure. In the present disclosure, the optical branching portion 120a and the optical modulation portion 170a are connected through the first optical waveguide, and the optical branching portion 120a is disposed in the front stage of the optical modulation portion 170a.

The optical modulation portion 170a is configured to modulate the light input to the optical input portion and to output the modulated light from the optical output portion. For example, a Mach-Zehnder type optical waveguide having the structure of a Mach-Zehnder interferometer can be used for the optical modulation portion 170a.

As shown in FIG. 2, the other end of the modulation optical waveguide 151a is connected to an optical branching portion 171a serving as an optical input portion of the optical modulation portion 170a. In the optical branching portion 171a, the modulation optical waveguide 151a branches into two branching waveguides 172a and 173a. The two branching waveguides 172a and 173a extend in parallel in the X direction and are connected to an optical multiplexing portion 174a serving as an optical output portion of the optical modulation portion 170a. The two branching waveguides 172a and 173a join together at the optical multiplexing portion 174a.

The optical modulation portion 170a applies an electric field to the branching waveguides 172a and 173a by controlling the voltage supplied to the electrode 200. The application of the electric field changes the refractive indexes of the branching waveguides 172a and 173a, respectively, and modulates the phase of the light based on this change in refractive index. The optical modulation portion 170a uses the interference effect to adjust the amplitude of the light after multiplexing by the optical multiplexing portion 174a, and outputs light of the desired intensity.

One end of the modulation optical waveguide 175a is connected to the optical output portion of the optical modulation portion 170a. The other end of the modulation optical waveguide 175a is connected to the optical input portion of the optical multiplexing portion 180. The modulation optical waveguide 175a constitutes the second optical waveguide of the present disclosure.

The optical multiplexing portion 180 has a multiple-input, single-output structure equipped with at least two optical input portions and one optical output portion, and is configured to multiplex two or more optical input signals into a single optical output signal. In the optical device 10A shown in FIGS. 1 and 2, the optical multiplexing portion 180 has a three-input, one-output structure, and is configured to multiplex the light input from the modulation optical waveguide 175a, the modulation optical waveguide 175b, and the modulation optical waveguide 175c. However, the optical multiplexing portion 180 is not limited to this structure, and for example, optical multiplexing portions with a two-input, one-output structure may be connected in multiple stages.

The optical multiplexing portion 180 is not particularly limited as long as it multiplexes the light propagating through the optical waveguides, and for example, an MMI coupler (multimode interference type coupler), a Y-branch (Y-shaped waveguide), a directional coupler, etc. can be used.

One end of the output optical waveguide 181 is connected to the optical output portion of the optical multiplexing portion 180. The output optical waveguide 181 is bent approximately vertically at the bend portion 182. The other end of the output optical waveguide 181 is connected to an optical output port 191 disposed on the fourth end face 14. The optical output port 191 is an optical output port that outputs the light multiplexed by the optical multiplexing portion 180, and the light output from the optical output port 191 is emitted to the outside.

The optical waveguide that propagates the laser light emitted from the visible laser light source 301b will now be described. An optical input port 110b is disposed on the first end face 11. The optical input port 110b is an optical input port for the laser light emitted from the visible laser light source 301b. The laser light emitted from the visible laser light source 301b is incident on the optical input port 110b.

An input optical waveguide 111b is connected to the optical input port 110b. One end of the input optical waveguide 111b is connected to the optical input port 110b. The other end of the input optical waveguide 111b is connected to the optical input portion of the optical branching portion 120b.

The optical branching portion 120b has a one-input, two-output structure equipped with one optical input portion and two optical output portions, and is configured to branch a single optical input signal into two optical output signals. The optical branching portion 120b is not particularly limited as long as it branches the light propagating through the optical waveguide, and for example, an MMI coupler (multimode interference type coupler), a Y-branch (Y-shaped waveguide), a directional coupler, etc. can be used.

One optical output portion of the optical branching portion 120b is connected to one end of the monitor optical waveguide 130b. The monitor optical waveguide 130b is bent midway and extends in the Y direction, and extends in the X direction in the vicinity of the third end face 13. The other end of the monitor optical waveguide 130b is connected to a monitor port 131b arranged on the second end face 12. The monitor port 131b is a monitoring light output port used when monitoring the laser light emitted from the visible laser light source 301b. In this specification, the light output from the optical branching portion 120b to the monitor optical waveguide 130b is sometimes referred to as monitoring light.

A tapered portion 135b that changes the waveguide width is disposed in the middle of the monitor optical waveguide 130b. The tapered portion 135b will be described later with reference to FIG. 6. In addition, a crossing waveguide 160a that crosses the modulation optical waveguide 140a is disposed in the monitor optical waveguide 130b.

The other optical output portion of the optical branching portion 120b is connected to one end of the modulation optical waveguide 140b. The other end of the modulation optical waveguide 140b is connected to the optical input portion of the high-order mode filter 150b. In this specification, the light output from the optical branching portion 120b to the modulation optical waveguide 140b is sometimes referred to as display light. The display light output from the optical branching portion 120b is green light, which is modulated by the optical modulation portion 170b and then multiplexed with display light of other wavelengths to be used, for example, as image projection light for XR glasses.

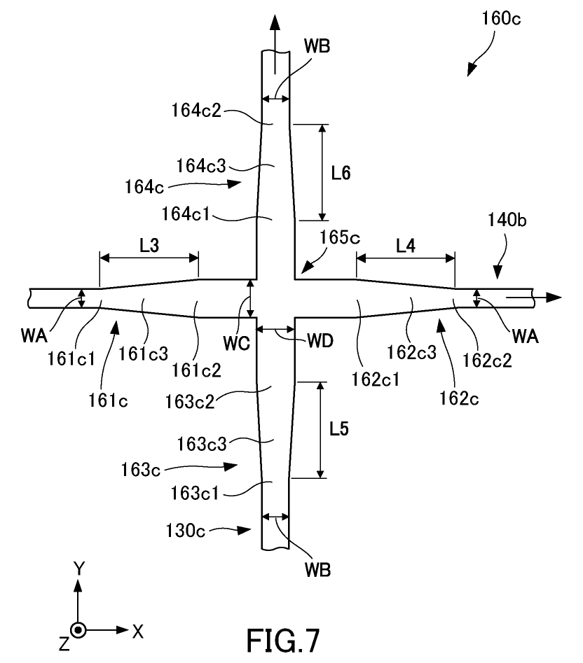

The modulation optical waveguide 140b is provided with a crossing waveguide 160c that crosses the monitor optical waveguide 130c. The crossing waveguide 160c will be described later with reference to FIG. 7.

The high-order mode filter 150b has an optical input portion and an optical output portion, and is configured to remove the high-order modes of the light input to the optical input portion and output only single-mode light from the optical output portion. The high-order mode filter 150b will be described later with reference to FIG. 9.

The optical output portion of the high-order mode filter 150b is connected to one end of the modulation optical waveguide 151b. The other end of the modulation optical waveguide 151b is connected to the optical input portion of the optical modulation portion 170b. The modulation optical waveguide 140b and the modulation optical waveguide 151b constitute the first optical waveguide of the present disclosure. In the present disclosure, the optical branching portion 120b and the optical modulation portion 170b are connected through the first optical waveguide, and the optical branching portion 120b is disposed in the front stage of the optical modulation portion 170b.

The optical modulation portion 170b is configured to modulate the light input to the optical input portion and output the modulated light from the optical output portion. For example, a Mach-Zehnder type optical waveguide having a Mach-Zehnder interferometer structure can be used for the optical modulation portion 170b.

As shown in FIG. 2, the other end of the modulation optical waveguide 151b is connected to an optical branching portion 171b serving as an optical input portion of the optical modulation portion 170b. In the optical branching portion 171b, the modulation optical waveguide 151b branches into two branching waveguides 172b and 173b. The two branching waveguides 172b and 173b extend in parallel in the X direction and are connected to an optical multiplexing portion 174b serving as an optical output portion of the optical modulation portion 170a. The two branching waveguides 172b and 173b join together at the optical multiplexing portion 174b.

The optical modulation portion 170b controls the voltage supplied to the electrode 200 to apply an electric field to the branching waveguides 172b and 173b. The application of an electric field changes the refractive indexes of the branching waveguides 172b and 173b, respectively, and modulates the phase of the light based on this change in refractive index. The optical modulation portion 170b uses the interference effect to adjust the amplitude of the light after multiplexing by the optical multiplexing portion 174b, and outputs light of the desired intensity.

One end of the modulation optical waveguide 175b is connected to the optical output portion of the optical modulation portion 170b. The other end of the modulation optical waveguide 175b is connected to the optical input portion of the optical multiplexing portion 180. The modulation optical waveguide 175b constitutes the second optical waveguide of the present disclosure.

As described above, the optical multiplexing portion 180 multiplexes the light input from the modulation optical waveguide 175a, the modulation optical waveguide 175b, and the modulation optical waveguide 175c. The light multiplexed by the optical multiplexing portion 180 is outputted to the outside from the optical output port 191 through the output optical waveguide 181.

The optical waveguide that propagates the laser light outputted from the visible laser light source 301c will now be described. An optical input port 110cis disposed on the first end face 11. The optical input port 110cis an optical input port for the laser light outputted from the visible laser light source 301c. The laser light outputted from the visible laser light source 301c is incident on the optical input port 110c.

An input optical waveguide 111c is connected to the optical input port 110c. One end of the input optical waveguide 111c is connected to the optical input port 110c. The other end of the input optical waveguide 111c is connected to the optical input portion of the optical branching portion 120c.

The optical branching portion 120c has a one-input, two-output structure equipped with one optical input portion and two optical output portions, and is configured to branch a single optical input signal into two optical output signals. The optical branching portion 120c is not particularly limited as long as it branches the light propagating through the optical waveguide, and for example, an MMI coupler (multimode interference coupler), a Y-branch (Y-shaped waveguide), a directional coupler, etc. can be used.

One optical output portion of the optical branching portion 120c is connected to one end of the monitor optical waveguide 130c. The monitor optical waveguide 130c is bent midway and extends in the Y direction, and extends in the X direction in the vicinity of the third end face 13. The other end of the monitor optical waveguide 130c is connected to a monitor port 131c arranged on the second end face 12. The monitor port 131c is a monitoring light output port used when monitoring the laser light emitted from the visible laser light source 301c. In this specification, the light output from the optical branching portion 120c to the monitor optical waveguide 130c is sometimes referred to as monitoring light.

A tapered portion 135c that changes the waveguide width is disposed in the middle of the monitor optical waveguide 130c. The tapered portion 135c will be described later with reference to FIG. 6. In addition, the monitor optical waveguide 130c is disposed with a crossing waveguide 160c that crosses the modulation optical waveguide 140b, and a crossing waveguide 160b that crosses the modulation optical waveguide 140a.

The other optical output portion of the optical branching portion 120c is connected to one end of the modulation optical waveguide 140c. The other end of the modulation optical waveguide 140c is connected to the optical input portion of the high-order mode filter 150c. In this specification, the light output from the optical branching portion 120c to the modulation optical waveguide 140c may be referred to as display light. The display light output from the optical branching portion 120c is blue light, which is modulated by the optical modulation portion 170c and then multiplexed with display light of other wavelengths to be used, for example, as image projection light for XR glasses.

The high-order mode filter 150c has an optical input portion and an optical output portion, and is configured to remove the higher modes of the light input to the optical input portion and output only single mode light from the optical output portion. The high-order mode filter 150c will be described later with reference to FIG. 9.

The optical output portion of the high-order mode filter 150c is connected to one end of the modulation optical waveguide 151c. The other end of the modulation optical waveguide 151c is connected to the optical input portion of the optical modulation portion 170c. The modulation optical waveguide 140c and the modulation optical waveguide 151c constitute the first optical waveguide of the present disclosure. In the present disclosure, the optical branching portion 120c and the optical modulation portion 170c are connected through the first optical waveguide, and the optical branching portion 120c is disposed in the front stage of the optical modulation portion 170c.

The optical modulation portion 170c is configured to modulate the light input to the optical input portion and output the modulated light from the optical output portion. For example, a Mach-Zehnder type optical waveguide having a Mach-Zehnder interferometer structure can be used for the optical modulation portion 170c.

As shown in FIG. 2, the other end of the modulation optical waveguide 151c is connected to an optical branching portion 171c serving as the optical input portion of the optical modulation portion 170c. In the optical branching portion 171c, the modulation optical waveguide 151c branches into two branching waveguides 172c and 173c. The two branching waveguides 172c and 173c extend in parallel in the X direction and are connected to an optical multiplexing portion 174c serving as the optical output portion of the optical modulation portion 170c. In the optical multiplexing portion 174c, the two branching waveguides 172c and 173c merge into the modulation optical waveguide 151c.

The optical modulation portion 170c controls the voltage supplied to the electrode 200 to apply an electric field to the branching waveguides 172c and 173c. The application of the electric field changes the refractive indexes of the branching waveguides 172c and 173c, respectively, and modulates the phase of the light based on this change in refractive index. The optical modulation portion 170c uses the interference effect to adjust the amplitude of the light after multiplexing by the optical multiplexing portion 174c, and outputs light of the desired intensity.

One end of the modulation optical waveguide 175c is connected to the optical output portion of the optical modulation portion 170c. The other end of the modulation optical waveguide 175c is connected to the optical input portion of the optical multiplexing portion 180. The modulation optical waveguide 175c constitutes the second optical waveguide of the present disclosure.

As described above, the optical multiplexing portion 180 multiplexes the light input from the modulation optical waveguide 175a, the modulation optical waveguide 175b, and the modulation optical waveguide 175c. The light multiplexed by the optical multiplexing portion 180 is output to the outside from the optical output port 191 through the output optical waveguide 181.

In FIGS. 1 and 2, the optical input ports 110a, 110b, and 110c are arranged at equal intervals on the first end face 11 along the Y direction, but these intervals do not necessarily have to be equal. In addition, some of the optical input ports 110a, 110b, and 110c may be arranged on different end faces of the optical device 10A.

In FIGS. 1 and 2, the monitor optical waveguides 130a, 130b, and 130c extend in the vicinity of the third end face 13, but may extend in the vicinity of the fourth end face 14. The monitor ports 131a, 131b, and 131c may be disposed on the third end face 13 or the fourth end face 14. Furthermore, a part of the monitor ports 131a, 131b, and 131c may be disposed on a different end face of the optical device 10A. In FIGS. 1 and 2, the optical output port 191 is disposed on the fourth end face 14, but may be disposed on another end face (for example, the second end face 12) as in a derivative example described later.

### Cross-sectional structure of optical device

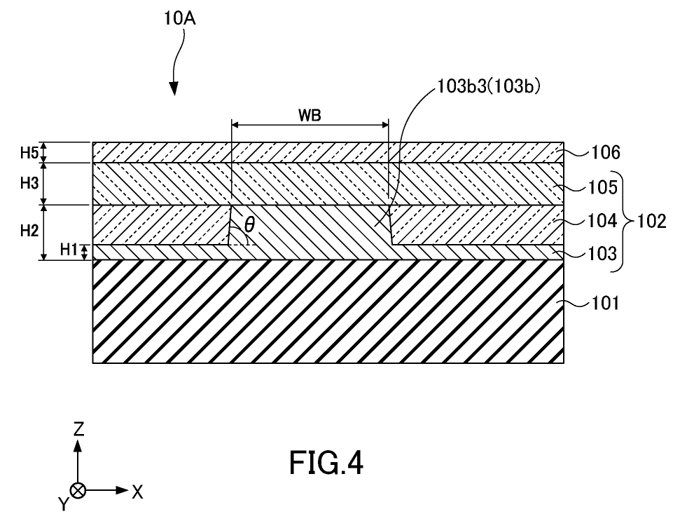

The cross-sectional structure of the optical device 10A will be described with reference to FIGS. 3 to 5. FIG. 3 is a cross-sectional view taken along line A-A in FIG. 1. FIG. 4 is a cross-sectional view taken along line B-B in FIG. 1. FIG. 5 is a cross-sectional view taken along line C-C in FIG. 1.

As shown in FIGS. 3 to 5, the optical device 10A has a substrate 101, an optical function layer 102, and a protective layer 106. The optical function layer 102 is composed of, for example, an optical waveguide layer 103, a first buffer layer 104, and a second buffer layer 105. The optical device 10A has a multi-layer structure in which the optical waveguide layer 103, the first buffer layer 104, the second buffer layer 105, and the protective layer 106 are stacked in this order on the substrate 101.

As shown in FIGS. 3 and 5, the electrode 200 and the pad portion 201 are disposed between the second buffer layer 105 and the protective layer 106. In FIG. 3, a drive electrode 200S and a reference electrode 200G are shown as the electrode 200.

The substrate 101 is a member that ensures the physical stability and durability of the entire optical device 10A. From the viewpoint of confining light in the optical waveguide formed in the optical function layer 102 and improving the optical propagation efficiency, it is advantageous to use a material with a lower refractive index than the material of the optical waveguide layer 103 for the substrate 101. For example, a substrate made of a material containing aluminum oxide (sapphire substrate), a Si substrate, a thermally oxidized silicon substrate, etc. can be used as the substrate 101.

The optical waveguide layer 103 functions as a waveguide core film that forms the optical waveguide. The optical waveguide layer 103 is a ferroelectric thin film made of a crystal expressed by the chemical formula ABX₃. The optical waveguide layer 103 can be made of a material that has an electro-optical effect. For example, a ferroelectric oxide such as lithium niobate (LiNbO₃), lithium tantalate (LiTaO₃), or barium titanate (BaTiO₃) can be used as the material that has the electro-optical effect. The optical device 10A using lithium niobate for the optical waveguide layer 103 is sometimes called an LN optical device, and an optical modulator with an LN optical device implemented is sometimes called an LN optical modulator.

When a sapphire single crystal substrate or a silicon single crystal substrate is used as the substrate 101, the lithium niobate film constituting the optical waveguide layer 103 can be formed as an epitaxial film on the upper surface of the substrate 101. The crystal orientation of the substrate 101 is not particularly limited, but since it serves as the base for the optical waveguide layer 103, it is advantageous that it has the same symmetry as the optical waveguide layer 103. Specifically, the lithium niobate film has three-fold symmetry, and when a c-axis oriented lithium niobate film is used as the optical waveguide layer 103, it is advantageous to use a substrate 101 with a c-plane if the substrate is a sapphire single crystal substrate, or a (111) plane if the substrate is a silicon single crystal substrate.

An epitaxial film is a film in which crystals grow based on the crystal orientation of the underlying substrate 101, and are oriented in a specific crystal orientation in accordance with the crystal structure of the substrate 101. Whether the optical waveguide layer 103 is an epitaxial film for the substrate 101 can be proven, for example, by performing peak intensity and pole analysis at the orientation position in 2θ-θ X-ray diffraction.

Specifically, when measuring by 2θ-θ X-ray diffraction, all peak intensities other than the target plane must be 10% or less, advantageously 5% or less, of the maximum peak intensity of the target plane. For example, in the case of an epitaxial film made of a c-axis oriented lithium niobate film, the peak intensity other than the (00L) plane is 10% or less, advantageously 5% or less, of the maximum peak intensity of the (00L) plane. Here, (00L) is a general designation for equivalent planes such as (001) and (002).

It is also necessary to observe the poles in the pole analysis. Checking the peak intensity at a specific orientation position only evaluates the crystal orientation in one direction. Therefore, even if it is confirmed that the peak intensity is below a certain value, if the crystal orientation is not aligned within the plane, the X-ray intensity will not increase at a specific angle position and a pole will not be observed. Since LiNbO₃ has a trigonal crystal structure, there are three poles of LiNbO₃ (014) in a single crystal.

It is known that lithium niobate films grow epitaxially in a twin state, in which crystals rotated 180° around the c-axis are symmetrically bonded. In this case, two of the three poles are symmetrically bonded, so that six poles are observed. In addition, when a lithium niobate film is formed on a silicon single crystal substrate with a (100) surface, the substrate is four-fold symmetric, so that 4 × 3 = 12 poles are observed. In this disclosure, lithium niobate films that grow epitaxially in a twin state are also included in the epitaxial film.

The composition of lithium niobate is LiₓNbA_{y}O_{z}. x is 0.5 ~ 1.2, advantageously 0.9 ~ 1.05. y is 0 ~ 0.5. z is 1.5 ~ 4.0, advantageously 2.5 ~ 3.5. The element A is an element other than Li, Nb, and O. Examples of the element A include K, Na, Rb, Cs, Be, Mg, Ca, Sr, Ba, Ti, Zr, Hf, V, Cr, Mo, W, Fe, Co, Ni, Zn, Sc, Ce, etc., and A may be a combination of two or more of these elements.

The optical waveguide layer 103 is not limited to one formed by epitaxial growth, and may be a thin film bonded to the upper surface of the substrate 101.

The optical waveguide layer 103 is composed of a slab layer 103a having a predetermined thickness and a ridge portion 103b protruding from the upper surface of the slab layer 103a. As shown in FIGS. 3 and 4, the ridge portion 103b is located at a position where the optical waveguide is to be formed. The ridge portion 103bconfines light therein and forms an optical waveguide that propagates the light. The ridge portions 103b shown in FIG. 3 form the branching waveguides 172c and 173c. The ridge portion 103bshown in FIG. 4 forms the monitor optical waveguide 130c. The cross-section of FIG. 5 does not include the ridge portion 103b, and the optical waveguide layer 103 is composed of a slab layer 103a having a predetermined thickness.

The ridge portion 103b may be a protruding portion formed by etching the optical waveguide layer 103, or may be formed by attaching the same material as the slab layer 103a to the upper surface of the slab layer 103a. The shape of the ridge portion 103b is not particularly limited, but here the ridge portion 103b is formed to have a cross-section in the form of rectangular shape.

By reducing the distance between adjacent ridge portions 103b, the electric field efficiency of the optical waveguides formed by the ridge portions 103b can be improved.

Instead of forming an optical waveguide by the ridge portion 103b, an optical waveguide may be formed by providing a region with a high refractive index in the optical waveguide layer 103. For example, a region with a high refractive index may be created locally in the optical waveguide layer 103 by a Ti diffusion method or a proton exchange method, and this region may be used as the optical waveguide.

As shown in FIGS. 3 to 5, the first buffer layer 104 is disposed on the upper surface of the slab layer 103a of the optical waveguide layer 103. In the vicinity of the position where the ridge portion 103b is formed, the first buffer layer 104 is filled between the adjacent ridge portions 103b and is disposed so as to cover the upper surface of the slab layer 103a and the side surface of the ridge portion 103b.

As shown in FIGS. 3 to 5, the second buffer layer 105 is disposed on the upper surface of the first buffer layer 104. In the vicinity of the formation position of the ridge portion 103b, the second buffer layer 105 is provided so as to cover the upper surface of the first buffer layer 104 and the upper surface of the ridge portion 103b.

The first buffer layer 104 and the second buffer layer 105 are made of a dielectric material having a smaller refractive index than the optical waveguide layer 103. The first buffer layer 104 and the second buffer layer 105 have the role of preventing visible light propagating through the optical waveguide layer 103 from being absorbed by the electrode 200.

The first buffer layer 104 and the second buffer layer 105 may be made of a material including, for example, silicon oxide (SiO₂), aluminum oxide (Al₂O₃), lanthanum oxide (La₂O₃), or a compound of these oxides. An example of the compound of the oxide is LaAlSiInO. The first buffer layer 104 and the second buffer layer 105 may be made of different materials. In this embodiment, silicon oxide is used as the material for the first buffer layer 104, and LaAlSiInO is used as the material for the second buffer layer 105. The first buffer layer 104 and the second buffer layer 105 may be made of the same material, or the first buffer layer 104 and the second buffer layer 105 may be disposed in an integrated state.

As shown in FIGS. 3 and 5, the electrode 200 and the pad portion 201 are disposed on the upper surface of the second buffer layer 105. In this embodiment, a configuration using a Z-cut lithium niobate film as the optical waveguide layer 103 is shown as an example. In this case, since the electro-optic effect is strongly expressed in the Z direction, it is advantageous that the electrode 200 is disposed directly above the ridge portion 103b forming the optical waveguide, as shown in FIG. 3. However, an X-cut lithium niobate film may be used as the optical waveguide layer 103. In this case, since the electro-optic effect is strongly expressed in the Y direction, it is advantageous that the electrode 200 is disposed on the side of the ridge portion 103b forming the optical waveguide.

As shown in FIGS. 3 and 4, the protective layer 106 is disposed so as to cover the upper surface of the second buffer layer 105 and the upper surface of the electrode 200. The protective layer 106 protects the upper surface of the second buffer layer 105 and the upper surface of the electrode 200, thereby making it possible in particular to prevent damage to the electrode 200. For example, silicon oxide (SiO₂) or silicon nitride (SiN) can be used as the material of the protective layer 106. The material of the protective layer 106 may be the same as or different from that of the first buffer layer 104 or the second buffer layer 105.

The protective layer 106 covers the upper surface of the second buffer layer 105 and the upper surface of the electrode 200 over the entire upper surface of the optical device 10A. However, as shown in FIG. 5, a part of the pad portion 201 is not covered by the protective layer 106, and the upper surface 201a of the pad portion 201 is exposed to the outside. Through this exposed upper surface 201a, the pad portion 201 can be electrically connected to an external power supply circuit or the like. Specifically, the protective layer 106 covers the entire side surface and part of the upper surface 201a of the pad portion 201, while being cut away at the upper surface 201a of the pad portion 201. As a result, a gap is formed between the ends 106a of the protective layer 106, and the upper surface 201a of the pad portion 201 is exposed to the outside through the gap. In addition, a metal layer may be formed on the upper part of the pad portion 201. This can improve the strength of the physical connection with the external power supply circuit.

The height of the slab layer 103a (height H1 in FIGS. 3 to 5 ) is not particularly limited, but is advantageously 0.1 μm ~ 0.3 μm, for example, and is set to 0.15 μm as an example. If the ridge portion 103bis extremely small, the light does not propagate properly, while if the ridge portion 103b is extremely large, the propagating light becomes multimode, so that it is advantageous to set the ridge portion 103b to an appropriate size. The height from the lower surface of the slab layer 103a to the upper surface of the ridge portion 103b (height H2 in FIGS. 3 to 5) is advantageously, for example, 0.5 μm ~ 1.5 μm, and is set to 0.7 μm as an example. The shape of the ridge portion 103bis not particularly limited, but can be a trapezoid with a base angle θ (angle θ in FIGS. 3 and 4) of 70° ~ 90°.

)The height of the second buffer layer 105 (height H3 in FIGS. 3 to 5) is not particularly limited, but can be set to about the same as the height H2, and is set to 0.7 μm as an example. The height of the electrode 200 and the pad portion 201 (height H4 in FIGS. 3 and 5) is not particularly limited, but is advantageously, for example, 0.1 μm ~ 5.0 μm, and is set to 2.0 μm as an example. The height of the protective layer 106 (height H5 in FIGS. 3 to 5) is not particularly limited, but is advantageously 0.5 μm ~ 0.7 μm, for example.

The distance between the centers of adjacent ridge portions 103b (width W1 in FIG. 3) is not particularly limited, but is advantageously 2.0 μm ~ 12 μm, for example, and is set to 4.0 μm, for example. The width of the electrode 200 is not particularly limited, but is advantageously 1.0 μm ~ 4.0 μm, for example, and is set to 3.0 μm, for example.

The distance between adjacent electrodes 200 is not particularly limited, but the distance between the sides of adjacent electrodes 200 (width W4 in FIG. 3) is advantageously 1.0 μm ~ 10 μm, for example, and is set to 2.0 μm, for example. The upper surface 201a of the pad portion 201 may be exposed to the outside as an electrical connection terminal, and the distance between the end 106a of the protective layer 106 and the side surface of the pad portion 201 (width W5 in FIG. 5) is set to 10 μm, for example.

The width of the ridge portion 103b corresponds to the width of the optical waveguide. In this embodiment, the width of the ridge portion 103b forming the monitor optical waveguides 130a, 130b, and 130c is set to be at least greater than the width of the ridge portion 103b forming the optical waveguides of the optical modulation portions 170a, 170b, and 170c.

FIG. 3 shows cross-sections of the ridge portions 103b1 and 103b2 forming the branching waveguides 172c and 173c of the optical modulation portion 170c, as the ridge portion 103b. The width WA (see FIG. 3) of the upper surface of the ridge portion 103b is advantageously, for example, 1.0 μm or less, and is set to 0.8 μm as an example. The width of the ridge portion 103b forming the branching waveguides 172a, 173a of the optical modulation portion 170a and the width of the ridge portion 103b forming the branching waveguides 172b, 173b of the optical modulation portion 170b are also set in the same manner.

FIG. 4 shows a cross-section of the ridge portion 103b3 forming the monitor optical waveguide 130c as the ridge portion 103b. The width WB (see FIG. 4) of the upper surface of the ridge portion 103b3 is advantageously, for example, 2.0 μm or more, and is set to 3.0 μm as an example. The width of the ridge portion 103b forming the monitor optical waveguides 130a and 130b is also set in the same manner.

Hereinafter, a specific example of the waveguide width of the optical device 10A in this embodiment will be described with reference to FIG. 2.

The waveguide width of the input optical waveguides 111a, 111b, and 111c connected to the optical input ports 110a, 110b, and 110c is set to width WA (e.g., 0.8 μm) in FIG. 3. At the optical branching portions 120a, 120b, and 120c, the optical waveguides branch into monitor optical waveguides 130a, 130b, and 130c and modulation optical waveguides 140a, 140b, and 140c.

The monitor optical waveguides 130a, 130b, and 130c have their waveguide width changed at the tapered portion 135a. The width of the optical waveguide from the optical branching portions 120a, 120b, and 120c to the tapered portions 135a, 135b, and 135c is set to width WA (e.g., 0.8 μm) in FIG. 3. In the tapered portions 135a, 135b, and 135c, the waveguide width increases toward the light propagation direction. The width of the optical waveguide from the tapered portions 135a, 135b, and 135c to the monitor ports 131a, 131b, and 131c is set to width WB (e.g., 3.0 μm) in FIG. 4.

As will be described later, the monitor optical waveguides 130a, 130b, and 130c may be configured so that the waveguide width changes at the crossing waveguides 160a, 160b, and 160c. In the crossing waveguides 160a, 160b, and 160c, the waveguide width of the monitor optical waveguides 130a, 130b, and 130c is set to be equal to or greater than the width WB (e.g., 3.0 μm) in FIG. 4.

The waveguide width of the modulation optical waveguides 140a, 140b, and 140c and the subsequent stages is set to the width WA (e.g., 0.8 μm) in FIG. 3. More specifically, the waveguide width of the modulation optical waveguides 140a, 140b, and 140c is set to the width WA (e.g., 0.8 μm) in FIG. 3. The waveguide width of the modulation optical waveguides 151a, 151b, and 151c is set to the width WA (e.g., 0.8 μm) in FIG. 3. The waveguide width of the branching waveguides 172a, 173a, 172b, 173b, 172c, and 173c is set to the width WA in FIG. 3 (e.g., 0.8 μm). The waveguide width of the modulation optical waveguides 175a, 175b, and 175c is set to the width WA in FIG. 3 (e.g., 0.8 μm). The waveguide width of the output optical waveguide 181 is set to the width WA in FIG. 3 (e.g., 0.8 μm).

As will be described later, the modulation optical waveguides 140a, 140b, and 140c are configured so that the waveguide width changes at the crossing waveguides 160a, 160b, and 160c. In the crossing waveguides 160a, 160b, and 160c, the waveguide width of the modulation optical waveguides 140a, 140b, and 140c is set to be larger than the width WA (e.g., 0.8 μm) in FIG. 3.

In this way, the waveguide width of the monitor optical waveguides 130a, 130b, and 130c is expanded by the tapered portions 135a, 135b, and 135c to allow the light waves to be multi-mode, thereby reducing the propagation loss due to scattering and absorption and increasing the amount of light propagation. This makes it possible to increase the amount of output light from the monitor ports 131a, 131b, and 131c.

### Tapered portion

The tapered portions 135a, 135b, and 135c will be described with reference to FIG. 6. FIG. 6 is a schematic plan view of the tapered portion 135a in FIGS. 1 and 2.

As shown in FIG. 6, the tapered portion 135a is disposed in the middle of the monitor optical waveguide 130a and is configured to change the waveguide width of the monitor optical waveguide 130a. The tapered portion 135a has a narrow end 135a1 located on the optical branching portion 120a side, a wide end 135a2 located on the monitor port 131a side, and a widened portion 135a3 disposed between the narrow end 135a1 and the wide end 135a2.

The width of the narrow end 135a1 is the same as the width WA (e.g., 0.8 μm) of the optical waveguide from the optical branching portion 120a to the tapered portion 135a. The width of the wide end 135a2 is the same as the width WB (e.g., 3.0 μm) of the waveguide from the tapered portion 135a to the monitor port 131a. The width of the widened portion 135a3 increases smoothly from the narrow end 135a1 toward the wide end 135a2. With this configuration, the tapered portion 135a smoothly expands the width of the monitor optical waveguide 130a in the propagation direction of the monitoring light.

The tapered portion 135a can be disposed at any position in the monitor optical waveguide 130a, and is advantageously disposed in the vicinity of the optical branching portion 120a. The length L1 (see FIG. 6) between the optical branching portion 120a and the narrow end 135a1 is advantageously, for example, 50 μm ~ 500 μm. By placing the tapered portion 135a in the vicinity of the optical branching portion 120a, the waveguide width can be increased in most areas of the monitor optical waveguide 130a.

The length L2 of the widened portion 135a3 (see FIG. 6) is advantageously set to an appropriate distance in consideration of reducing propagation loss and improving the efficiency of the manufacturing process. The length L2 of the widened portion 135a3 is not particularly limited, but is advantageously 50 μm ~ 150 μm, and is set to 100 μm, for example.

Here, the configuration of the tapered portion 135a is illustrated in FIG. 6 and has been explained hereinbefore, but the tapered portions 135b and 135c also have similar configurations, respectively.

By widening the waveguide width of the monitor optical waveguides 130a, 130b, and 130c by the tapered portions 135a, 135b, and 135c, the monitoring light propagating through the monitor optical waveguides 130a, 130b, and 130c is made multi-mode. This makes it possible to reduce the propagation loss of the monitoring light in the monitor optical waveguides 130a, 130b, and 130c, and to allow a sufficient amount of monitoring light to be emitted from the monitor ports 131a, 131b, and 131c.

### Crossing Waveguides

The crossing waveguides 160a, 160b, and 160c will be described with reference to FIGS. 7 and 8. FIG. 7 is a schematic plan view of the crossing waveguide 160c in FIGS. 1 and 2. FIG. 8 is a schematic plan view of the connected crossing waveguides 160a, 160b, and 160c in FIGS. 1 and 2.

In the optical device 10A of this embodiment, the monitor optical waveguides 130a, 130b, and 130c extend midway in the Y direction and reach the vicinity of the third end face 13. This configuration results in generating an intersection between the monitor optical waveguide 130b and the modulation optical waveguide 140a, an intersection between the monitor optical waveguide 130c and the modulation optical waveguide 140a, and an intersection between the monitor optical waveguide 130c and the modulation optical waveguide 140b.

At each intersection, propagation loss due to scattering and the like increases, and as a result, the amount of output light from the monitor ports 131a, 131b, and 131c and the optical output port 191 may decrease. Hereinafter, such loss may be referred to as "intersection loss".

In the optical device 10A of this embodiment, the crossing waveguides 160a, 160b, and 160c are disposed at each intersection, taking into consideration the intersection loss that may occur at each intersection portion.

The crossing waveguide 160c shown in FIG. 7 will now be described. As shown in FIG. 7, the crossing waveguide 160c is disposed at the intersection portion of the monitor optical waveguide 130c and the modulation optical waveguide 140b, and is configured to change the waveguide width of each of the monitor optical waveguide 130c and the modulation optical waveguide 140b. In order to reduce the effect of the intersection loss at the intersection portion, it is advantageous to make the monitor optical waveguide 130c and the modulation optical waveguide 140b intersect approximately perpendicularly.

The crossing waveguide 160c has four tapered portions 161c, 162c, 163c, and 164c and a cruciform portion 165c.

The tapered portion 161c constitutes a part of the optical waveguide that propagates the display light. The tapered portion 161c is disposed on the optical branching portion 120b side with respect to the intersection portion. The tapered portion 161c has a narrow end portion 161c1 disposed on the optical branching portion 120b side, a wide end portion 161c2 disposed on the optical modulation portion 170b side, and a widened portion 161c3 disposed between the narrow end portion 161c1 and the wide end portion 161c2.

The width of the narrow end portion 161c1 is the same as the width WA (e.g., 0.8 μm) of the modulation optical waveguide 140b. The width WC of the wide end portion 161c2 is set larger than the width WA of the narrow end portion 161c1. The width WC of the wide end portion 161c2 is advantageously, for example, 2.0 μm ~ 5.0 μm, and is set to 3.6 μm as an example.

The width of the widened portion 161c3 increases smoothly from the narrow end portion 161c1 toward the wide end portion 161c2. With this configuration, the tapered portion 161c smoothly expands the width of the modulation optical waveguide 140b toward the propagation direction of the display light.

The tapered portion 162c constitutes a part of the optical waveguide that propagates the display light. The tapered portion 162c is disposed on the optical modulation portion 170b side with respect to the intersection portion. The tapered portion 162c has a wide end portion 162c1 located on the optical branching portion 120b side, a narrow end portion 162c2 located on the optical modulation portion 170b side, and a narrowed portion 162c3 disposed between the wide end portion 162c1 and the narrow end portion 162c2.

The width of the wide end portion 162c1 is the same as the width WC of the wide end portion 161c2. The width of the narrow end portion 162c2 is the same as the width WA of the modulation optical waveguide 140b (e.g., 0.8 μm). The width of the narrowed portion 162c3 smoothly decreases from the wide end portion 162c1 toward the narrow end portion 162c2. With this configuration, the tapered portion 162c smoothly reduces the width of the modulation optical waveguide 140b in the propagation direction of the display light.

The length L3 of the widened portion 161c3 (see FIG. 7) and the length L4 of the narrowed portion 162c3 (see FIG. 7) may be the same or different. The length L3 of the widened portion 161c3 and the length L4 of the narrowed portion 162c3 are not particularly limited, but for example are advantageously 50 μm ~ 150 μm, and as an example, both the lengths L3 and L4 are set to 100 μm.

The tapered portion 163c constitutes a part of the optical waveguide that propagates the monitoring light. The tapered portion 163c is disposed on the optical branching portion 120c side with respect to the intersection portion. The tapered portion 163c has a narrow end portion 163c1 disposed on the optical branching portion 120c side, a wide end portion 163c2 disposed on the monitor port 131c side, and a widened portion 163c3 disposed between the narrow end portion 163c1 and the wide end portion 163c2.

The width of the narrow end portion 163c1 is the same as the width WB (e.g., 3.0 μm) of the monitor optical waveguide 130c. The width WC of the wide end portion 163c2 is set to be equal to or larger than the width WB of the narrow end portion 163c1. The width WC of the wide end portion 163c2 is, for example, advantageously 3.0 μm ~ 5.0 μm, and is set to 3.6 μm as an example.

The width of the widened portion 163c3 smoothly increases from the narrow end portion 163c1 toward the wide end portion 163c2. With this configuration, the tapered portion 163c smoothly expands the width of the monitor optical waveguide 130c in the propagation direction of the monitoring light.

The tapered portion 164c constitutes a part of the optical waveguide that propagates the monitoring light. The tapered portion 164c is located on the monitor port 131c side with respect to the intersection portion. The tapered portion 164c has a wide end portion 164c1 located on the optical branching portion 120c side, a narrow end portion 164c2 located on the monitor port 131c side, and a narrowed portion 164c3 located between the wide end portion 164c1 and the narrow end portion 164c2.

The width of the wide end portion 164c1 is the same as the width WC of the wide end portion 163c2. The width of the narrow end portion 164c2 is the same as the width WB (e.g., 3.0 μm) of the monitor optical waveguide 130c. The width of the narrowed portion 164c3 smoothly decreases from the wide end portion 164c1 toward the narrow end portion 164c2. With this configuration, the tapered portion 164c smoothly reduces the width of the monitor optical waveguide 130b in the propagation direction of the monitoring light.

The length L5 of the widened portion 163c3 (see FIG. 7) and the length L6 of the narrowed portion 164c3 (see FIG. 7) may be the same or different. The length L5 of the widened portion 163c3 and the length L6 of the narrowed portion 164c3 are not particularly limited, but are advantageously 50 μm ~ 150 μm, for example, and as an example, both lengths L5 and L6 are set to 100 μm.

The cruciform portion 165c is formed in a cross shape and constitutes the intersection center between the monitor optical waveguide 130c and the modulation optical waveguide 140b. The cruciform portion 165c connects the wide end portion 161c2 of the tapered portion 161c and the wide end portion 162c1 of the tapered portion 162c. The cruciform portion 165c connects the wide end portion 163c2 of the tapered portion 163c and the wide end portion 164c1 of the tapered portion 164c.

The crossing waveguide 160c is configured to expand the waveguide width of the monitoring light and the waveguide width of the display light at the intersection portion of the monitor optical waveguide 130c and the modulation optical waveguide 140b. The monitoring light and the display light pass through the crossing waveguide 160c in a multi-mode state. This reduces the cross-over loss and increases the amount of light propagation, and increases the amount of output light from the monitor port 131c and the optical output port 191.

The configuration of the crossing waveguide 160c has been described with reference to FIG. 7, but the crossing waveguides 160a and 160b can have a similar configuration.

In addition, when multiple crossing waveguides are arranged in the same optical waveguide, the crossing waveguides may be connected to each other by omitting a part of the tapered portion. In this embodiment, as shown in FIG. 8, the crossing waveguide 160a and the crossing waveguide 160b are connected to each other.

The crossing waveguide 160a is arranged at the intersection portion between the monitor optical waveguide 130b and the modulation optical waveguide 140a. As shown in FIG. 8, the crossing waveguide 160a has three tapered portions 161a, 163a, and 164a, and a cruciform portion 165a.

The crossing waveguide 160b is arranged at the intersection portion between the monitor optical waveguide 130c and the modulation optical waveguide 140a. As shown in FIG. 8, the crossing waveguide 160b has three tapered portions 162b, 163b, and 164b, and a cruciform portion 165b.

The crossing waveguide 160a does not have a tapered portion on the optical modulation portion 170a side of the intersection portion. The crossing waveguide 160b does not have a tapered portion on the optical branching portion 120a side of the intersection portion. Instead, the cruciform portion 165a of the crossing waveguide 160a and the cruciform portion 165b of the crossing waveguide 160b are connected by a connecting portion 166. The width WD of the connecting portion 166 is advantageously, for example, 2.0 μm ~ 5.0 μm, and is set to 3.6 μm as an example.

When multiple crossing waveguides are arranged on the same optical waveguide, the tapered portions between the crossing waveguides may be omitted and the crossing waveguides may be connected by the connecting portion 166. This makes it possible to shorten the length of the waveguide in the tapered portion, thereby reducing the optical loss due to propagation.

### High-order mode filter

The high-order mode filters 150a, 150b, and 150c will be described with reference to FIG. 9. FIG. 9 is a schematic plan view of the high-order mode filter 150a in FIGS. 1 and 2. Here, the configuration of the high-order mode filter 150a will be described with reference to FIG. 9, but the high-order mode filters 150b and 150c have a similar configuration.

The high-order mode filter 150a is disposed between the crossing waveguide 160b and the optical modulation portion 170a.

In the modulation optical waveguide 140a, the display light after passing through the crossing waveguides 160a and 160b is multi-mode. Also, depending on the mounting accuracy of the visible laser light sources 301a, 301b, and 301c, it may become multi-mode when light is incident. In order to improve the modulation efficiency of the optical modulation portion 170a, it is necessary to remove the high-order modes of the display light and convert it to a single mode.

The high-order mode filter 150a is configured to remove the high-order modes of the display light and convert it to a single mode. More specifically, the high-order mode filter 150a has a curved waveguide 150a1 formed in a semicircular arc shape in a plan view, and curved portions 150a2 and 150a3 that connect the curved waveguide 150a1 to the modulation optical waveguides 140a and 151a. The curved portions 150a2 and 150a3 are each structured to bend the optical waveguide by 90°. The semicircular curved waveguide 150a1 is connected between the curved portions 150a2 and 150a3.

When passing through a curved optical waveguide, high-order mode light is likely to suffer loss due to its structural characteristics. By passing multi-mode light through a curved optical waveguide, it is possible to selectively pass only specific modes and realize conversion to single mode. The high-order mode filter 150a is configured to remove high-order modes from the display light using the curved waveguide 150a1 and convert it to single mode.

In order to remove the multi-mode of the display light that has passed through the curved waveguide 150a1 and convert it to single mode, it is advantageous to set the shape of the curved waveguide 150a1 appropriately.

The width WE of the curved waveguide 150a1 is advantageously 0.4 μm ~ 0.8 μm, and is set to, for example, 0.6 μm.

The curvature (radius of curvature R) of the curved waveguide 150a1 is advantageously set individually depending on the wavelength of the display light (for example, the three primary colors of red, green, and blue). The radius of curvature R refers to the distance from the center of the semicircular arc to the center position of the optical waveguide. When the display light is red light (wavelength 637 nm), the radius of curvature R of the curved waveguide 150a1 is advantageously 40 μm ~ 80 μm, and is set to, for example, 60 μm. When the display light is green light (wavelength 520 nm), the radius of curvature R of the curved waveguide 150a1 is advantageously 60 μm to 100 μm, and is set to, for example, 80 μm. When the display light is blue light (wavelength 455 nm), the radius of curvature R of the curved waveguide 150a1 is advantageously 100 μm ~ 140 μm, and is set to, for example, 120 μm.

In this embodiment, the high-order mode filter 150a is configured to remove the high-order mode of red light, the high-order mode filter 150b is configured to remove the high-order mode of green light, and the high-order mode filter 150c is configured to remove the high-order mode of blue light.

The high-order modes contained in the display light of each wavelength are effectively removed by the high-order mode filters 150a, 150b, and 150c, and the display light modulated by the optical modulation portions 170a, 170b, and 170c is made into a single mode, thereby improving the modulation efficiency of the optical modulation portions 170a, 170b, and 170c.

### Manufacturing method of the light source module

The manufacturing method of the light source module 1A will now be described.

When manufacturing the light source module 1A, first, the optical device 10A is manufactured and prepared. The optical device 10A can be manufactured by a known method after designing the pattern of the optical waveguide described above. Specifically, a substrate 101 processed to have a predetermined thickness is prepared, and the optical function layer 102, the electrode 200, and the protective layer 106 are laminated on the substrate 101. For example, when forming a lithium niobate film as an epitaxial film on a single crystal substrate made of sapphire or the like, the epitaxial film is formed by sputtering, CVD, or the like in accordance with the crystal orientation of the single crystal substrate. The ridge portion 103bcan be formed by dry etching after a pattern (mask) is formed on the lithium niobate film by photolithography, for example.

Then, the relative positions of the visible laser light sources 301a, 301b, and 301c with respect to the optical device 10A are adjusted and fixed by active alignment.

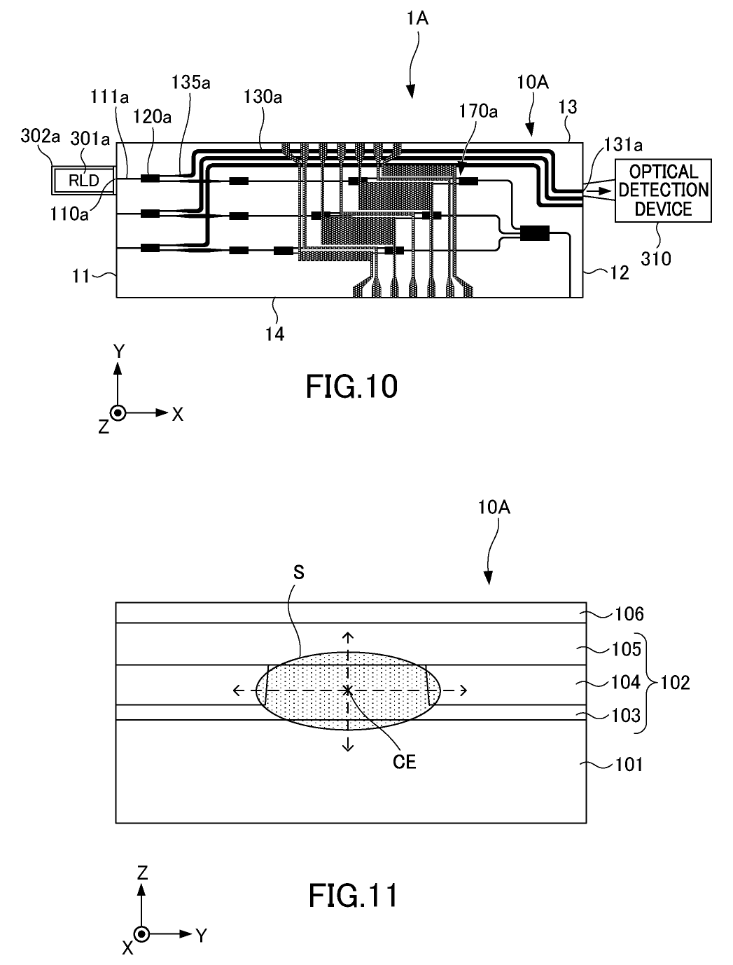

FIG. 10 is a diagram for explaining active alignment performed in the manufacturing process of the light source module 1A in this embodiment. FIG. 10 shows a schematic diagram of the state in which active alignment of the visible laser light source 301a is being performed.

When performing active alignment of the visible laser light source 301a, the visible laser light source 301a is disposed in the vicinity of the optical input port 110a, and the optical detection device 310 is disposed in the vicinity of the monitor port 131a. The optical detection device 310 is a device that detects the amount of light (light intensity), and can use, for example, a photodetector that outputs an electrical signal depending on the amount of light received. The optical detection device 310 is used to detect the amount of light output from the monitor port 131a.

The visible light incident from the optical input port 110a propagates through the input optical waveguide 111a, the optical branching portion 120a, and the monitor optical waveguide 130a, and is output from the monitor port 131a as monitoring light. In the optical device 10A, the optical branching portion 120a is disposed in the front stage of the optical modulation portion 170a.

When the monitoring light is configured to pass through the optical modulation portion 170a, a sufficient amount of monitoring light may not be obtained due to the initial phase difference between the branching waveguides 172a and 173a in the optical modulation portion 170a. In this case, it is necessary to adjust the phase of the light propagating through the branching waveguides 172a and 173a by applying a voltage to the optical modulation portion 170a.

In contrast, in the optical device 10A of this embodiment, the visible light split by the optical branching portion 120a is output as monitoring light from the monitor port 131a without passing through the optical modulation portion 170a. Therefore, in this embodiment, it is not necessary to supply power to the optical device 10A to adjust the phase in the optical modulation portion 170a, and a sufficient amount of monitoring light can be output from the monitor port 131a.

The visible light emitted from the visible laser light source 301a is made incident on the optical input port 110a, and the light emitted from the monitor port 131a is made incident on the optical detection device 310. The optical detection device 310 detects the amount of output light from the monitor port 131a and outputs the detection result. Based on the detection result of this optical detection device 310, the relative position of the visible laser light source 301a with respect to the optical device 10A is adjusted so that the amount of output light from the monitor port 131a is at least a certain level or more, ideally at its maximum. The relative position here means the xyz coordinate position of the visible laser light source 301a with respect to the optical device 10A, and the attitude of the visible laser light source 301a (the angle of incidence of visible light to the optical device 10A).

FIG. 11 is a diagram for explaining the concept of active alignment performed in this embodiment. In FIG. 11, the vicinity of the optical input port 110a of the first end face 11 is illustrated.

As shown in FIG. 11, the visible light emitted from the visible laser light source 301a is irradiated in the vicinity of the optical input port 110a. The visible light has an irradiation range (spot S) with a certain spread. The optical axis of the visible light, which is a laser light, is located at the center of the spot S. Normally, the output light amount of the monitor port 131a is maximized by aligning the center position CE of the optical input port 110a with the optical axis of the visible light.

In active alignment, the output light amount of the monitor port 131a detected by the optical detection device 310 is detected in real time, and the relative position of the visible laser light source 301a with respect to the optical device 10A is determined so that the output light amount is maximized. For example, the visible laser light source 301a is moved in the Y direction and the Z direction while the emission surface of the visible laser light source 301a and the first end face 11 are faced to each other and kept at a certain distance. The position at which the output light amount of the monitor port 131a is maximized is determined.

When the output light amount of the monitor port 131a is at its maximum, the optical axis of the visible light emitted from the visible laser light source 301a coincides with the center position of the optical input port 110a. In this state, the visible laser light source 301a is fixed to the optical device 10A. For example, the subcarrier 302a on which the visible laser light source 301a is mounted is joined to the substrate 101 of the optical device 10A.

In this way, the incidence efficiency of visible light into the optical input port 110a is optimized by the active alignment using the monitoring light. In addition, the position of the visible laser light source 301a can be precisely adjusted, and the operating efficiency and the optical performance of the entire optical device 10A can be improved.

Here, the active alignment for the visible laser light source 301a has been described, but the active alignment can also be performed for the visible laser light sources 301b and 301c in a similar manner.

### Anti-reflection device

The visible light emitted from the visible laser light sources 301a, 301b, and 301c is branched by the optical branching portions 120a, 120b, and 120c, and is simultaneously emitted from the monitor ports 131a, 131b, and 131c and the optical output port 191.

The monitoring light is required when performing the active alignment, but is not required when using the display light emitted from the optical output port 191. However, even when the monitoring light is not required, the monitoring light is emitted from the monitor ports 131a, 131b, and 131c.

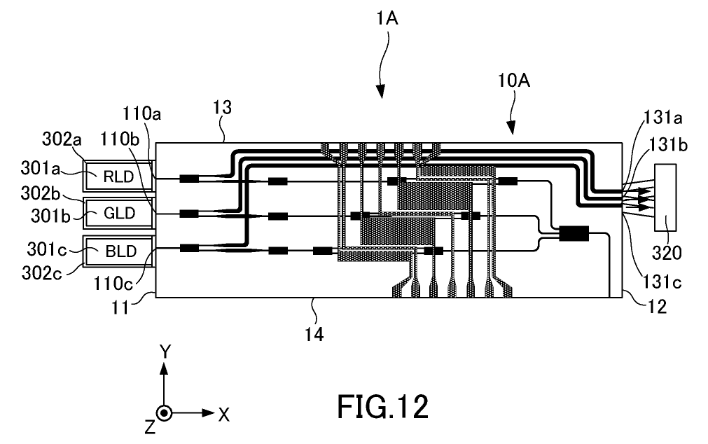

FIG. 12 is a diagram for explaining the state in which the anti-reflection device 320 is disposed in the vicinity of the monitor ports 131a, 131b, and 131c of the light source module 1A in this embodiment. As shown in FIG. 12, by disposing the anti-reflection device 320 at the monitor ports 131a, 131b, and 131c, it is possible to prevent leakage of the monitoring light when the display light is used. This makes it possible to suppress visual flickering due to leakage of the monitoring light, and to prevent interference with the display light.

The anti-reflection device 320 has a function of attenuating or scattering unnecessary monitoring light emitted from the monitor ports 131a, 131b, and 131c. As the anti-reflection device 320, for example, a light attenuating device such as a silicon material or an ND filter, or a light scattering device such as a diffuser or a member with a textured finish can be used.

The anti-reflection device 320 may be disposed so as to be in contact with the second end face 12, or may be disposed at a position a certain distance away from the second end face 12.

The anti-reflection device 320 may be detachably mounted on the monitor ports 131a, 131b, and 131c. When the monitoring light is not required, the monitor ports 131a, 131b, and 131c are covered with the anti-reflection device 320. When the monitoring light is required, the anti-reflection device 320 is removed from the monitor ports 131a, 131b, and 131c.

### Optical System

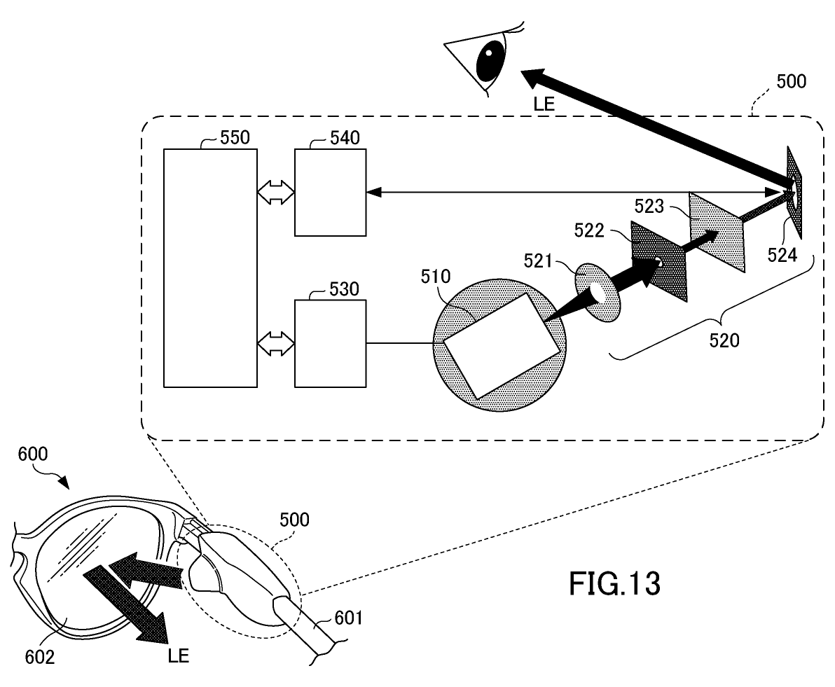

The optical system 500 in this embodiment will be described. FIG. 13 is a conceptual diagram of the optical system 500 in this embodiment.

The optical system 500 constitutes, for example, an image display device that displays information that can be visually recognized as an image (still image and moving image). The optical system 500 can be implemented in, for example, a glasses-type terminal such as XR glasses 600.

The optical system 500 shown in FIG. 13 includes a light source module 510, an optical assembly 520, a laser driver 530, an optical scanning mirror driver 540, and a video controller 550 that controls these above drivers.

The optical system 500 can be equipped with the light source module 1A of this embodiment as the light source module 510. The light source module 510 is installed, for example, in the frame 601 of the XR glasses 600.

The optical assembly 520 optically processes the output light LE emitted by the light source module 510. The output light LE is visible light (display light) output from the optical output port 191 of the light source module 1A of this embodiment.

The optical assembly 520 includes, for example, a collimator lens 521, a slit 522, a ND filter 523, and an optical scanning mirror 524. The optical assembly 520 shown in FIG. 13 is an example, and other configurations may be used. The light source module 510 and the optical scanning mirror 524 constitute the optical engine of the present disclosure.

For example, a MEMS mirror can be used as the optical scanning mirror 524. In order to project a two-dimensional image, it is advantageous to use a two-axis MEMS mirror that vibrates so as to reflect laser light by changing angles in the horizontal and vertical directions as the optical scanning mirror 524.

In the XR glasses 600 shown in FIG. 13, the light source module 510 attached to the frame 601 emits output light LE. The output light LE is reflected by the optical scanning mirror 524 and further reflected by the lens 602 of the XR glasses 600. The light reflected by the lens 602 is incident on the human eyeball and forms an image on the retina. This makes it possible to allow the image to be visually recognized.

### Derivation of the First Embodiment

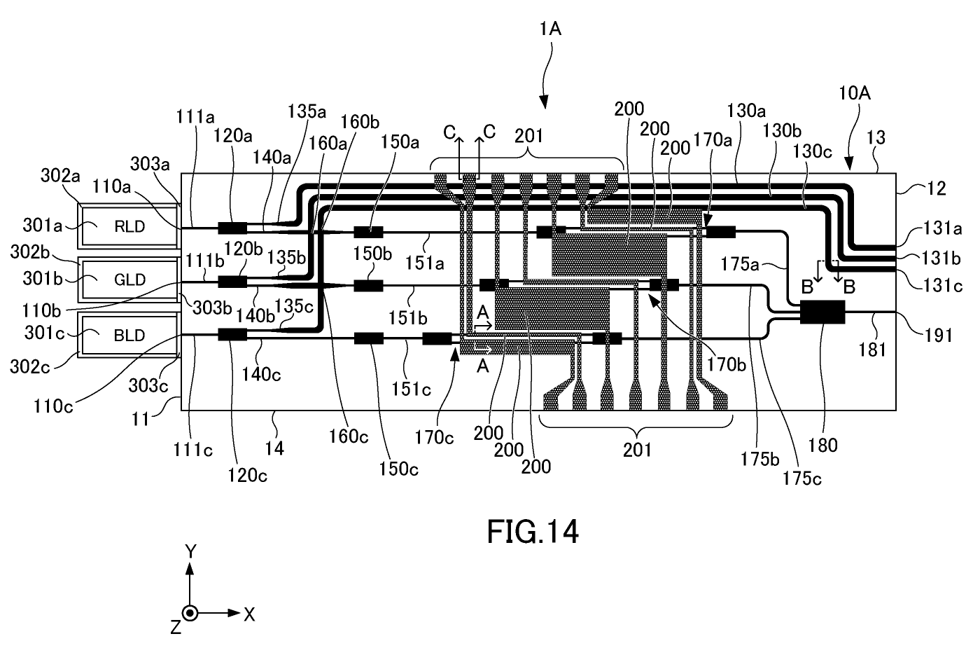

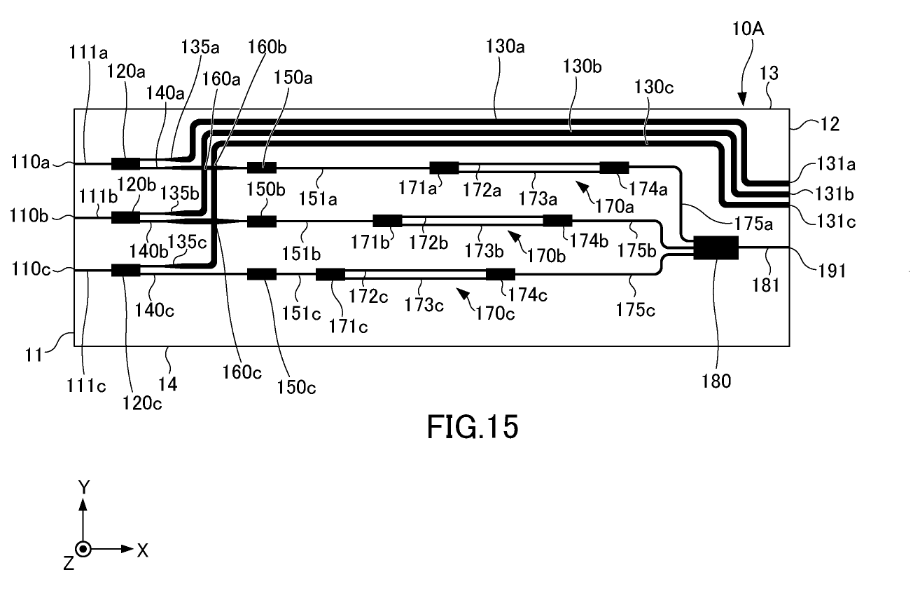

FIG. 14 is a schematic plan view of the light source module 1A in a derivative example of the first embodiment. FIG. 15 is a schematic plan view showing the state in which the electrode 200 and the pad portion 201 are removed from the light source module 1A in FIG. 14.

As shown in FIGS. 14 and 15, the optical output port 191 may be disposed on the second end face 12. The output optical waveguide 181 connected to the optical multiplexing portion 180 extends linearly in the X direction and is connected to the optical output port 191 provided on the second end face 12. By disposing the optical output port 191 on the second end face 12 located on the opposite side of the light incidence surface (first end face 11), the flexibility of mounting the light source module 1A can be increased.

### Second embodiment

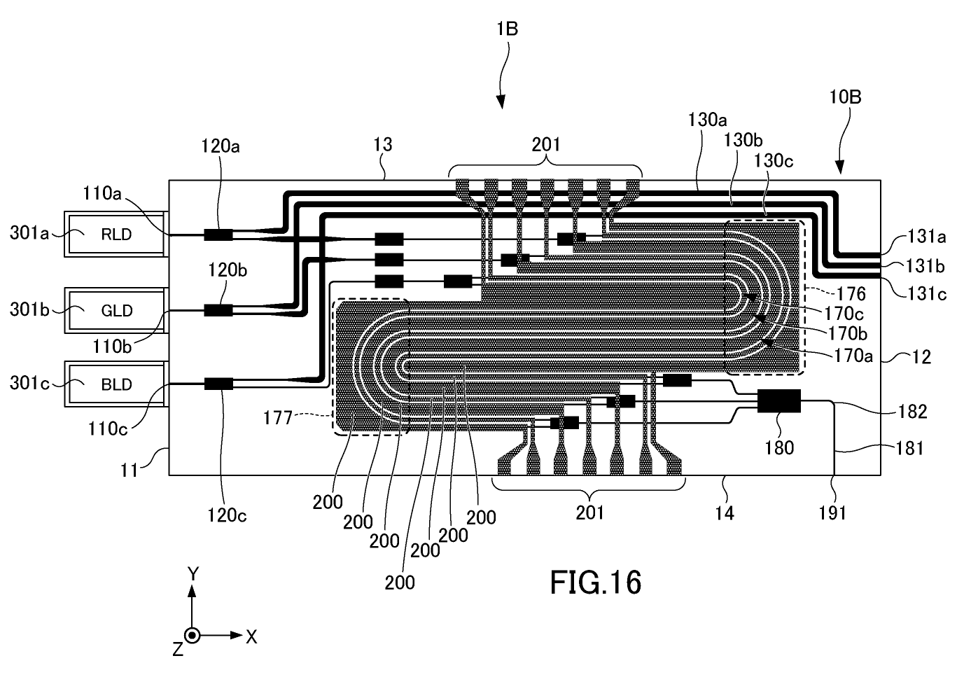

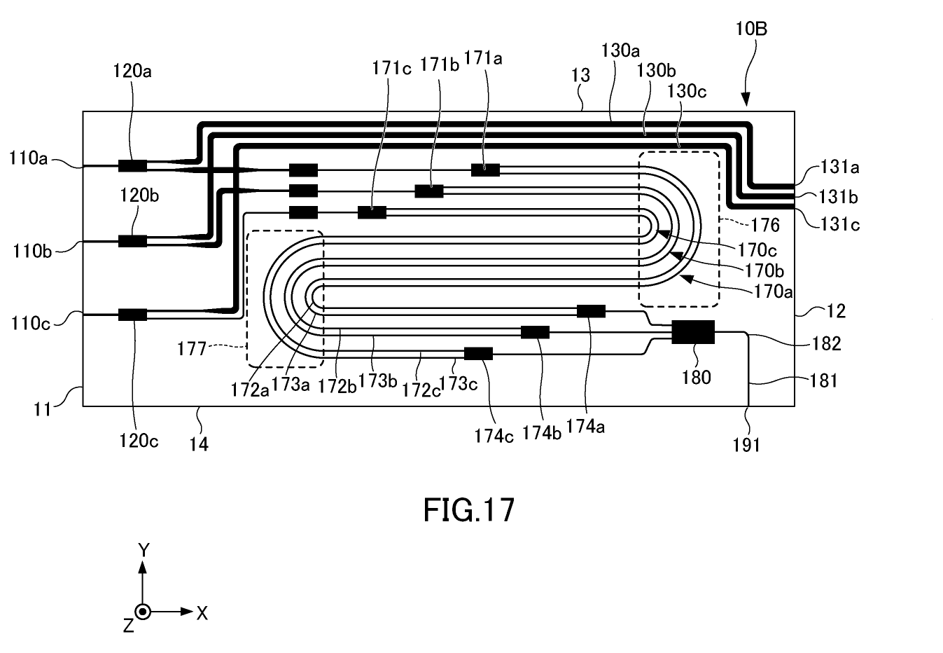

A second embodiment of the present disclosure will be described. FIG. 16 is a schematic plan view of the light source module 1B in this embodiment. FIG. 17 is a schematic plan view showing the state in which the electrode 200 and the pad portion 201 are removed from the light source module 1B of FIG. 16. In the second embodiment, the same components as those in the first embodiment are given the same reference numerals, and the description is omitted as appropriate.

The light source module 1B in the second embodiment has an optical device 10B. The optical device 10B differs from the optical device 10A in the first embodiment in that the Mach-Zehnder type optical waveguides constituting the optical modulation portions 170a, 170b, and 170c are constituted by folded optical waveguides. Furthermore, the electrode 200 of the optical device 10B has a shape suited to the folded optical waveguide.

As shown in FIGS. 16 and 17, the branching waveguides 172a and 173a constituting the optical modulation portion 170a have folded portions 176 and 177 that invert the light propagation direction. The branching waveguides 172a and 173a are curved in a U-shape at two folded portions 176 and 177. Except for the folded portions 176 and 177, the branching waveguides 172a and 173a are linear and extend parallel to the Y direction. Similarly, the branching waveguides 172b and 173b constituting the optical modulation portion 170b and the branching waveguides 172c and 173c constituting the optical modulation portion 170c are also curved in a U-shape at the folded portions 176 and 177.

By adopting the folded type of optical waveguides for the optical modulation portions 170a, 170b, and 170c, the length (length in the X direction) of the optical device 10B in the light incidence direction of the optical input ports 110a, 110b, and 110c can be shortened. As a result, the entire optical device 10B can be made smaller.

The monitor optical waveguides 130a, 130b, and 130c are connected to the monitor ports 131a, 131b, and 131c disposed on the second end face 12, and extend in the light incidence direction (X direction) of the optical input ports 110a, 110b, and 110c. By shortening the length of the optical device 10B in the X direction, the monitor optical waveguides 130a, 130b, and 130c can be shortened, thereby making it possible to reduce the propagation loss of the monitoring light.

Furthermore, by adopting the folded type of optical waveguide, the length of the branching waveguides 172a, 173a, 172b, 173b, 172c, and 173c to which an electric field is applied can be sufficiently ensured. As a result, the drive voltage required for modulating the display light can be reduced, thereby making it possible to reduce the power consumption of the entire optical device 10B.

### Derivation of the second embodiment

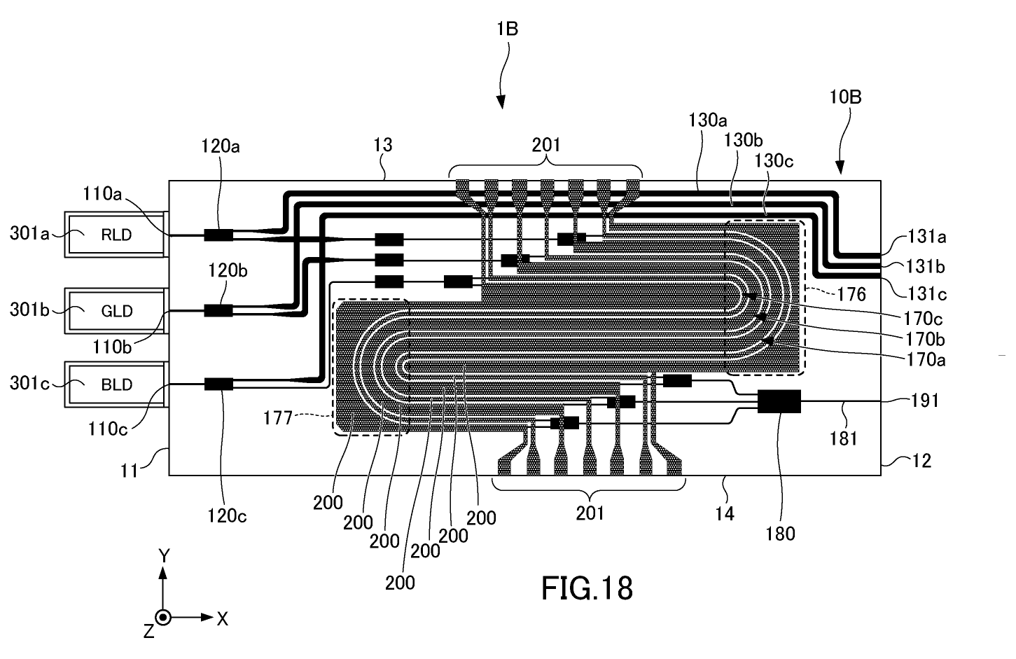

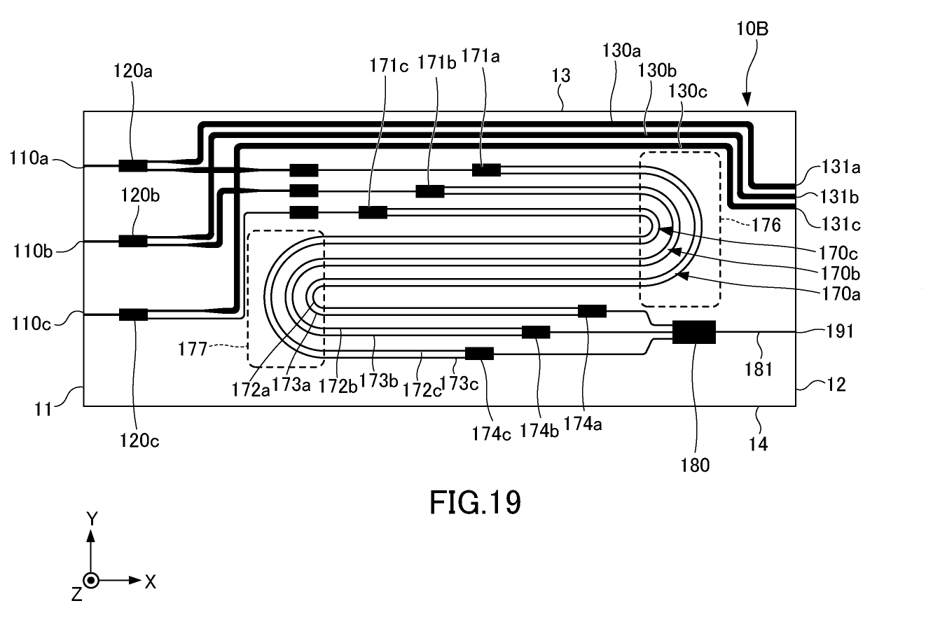

FIG. 18 is a schematic plan view of a light source module 1B in a derivative example of the second embodiment. FIG. 19 is a schematic plan view showing the state in which the electrode 200 and the pad portion 201 are removed from the light source module 1B in FIG. 18.

As shown in FIG. 18 and FIG. 19, the optical output port 191 may be disposed on the second end face 12. The output optical waveguide 181 connected to the optical multiplexing portion 180 extends linearly in the X direction and is connected to the optical output port 191 disposed on the second end face 12. By disposing the optical output port 191 on the second end face 12 located on the opposite side of the light incident surface (first end face 11), the flexibility of mounting the light source module 1B can be increased.

The light source module 1B in the second embodiment can perform active alignment in the same manner as the first embodiment. Similarly, it is also possible to dispose an anti-reflection device 320 and to incorporate the light source module 1B into the optical system 500.

### Third embodiment

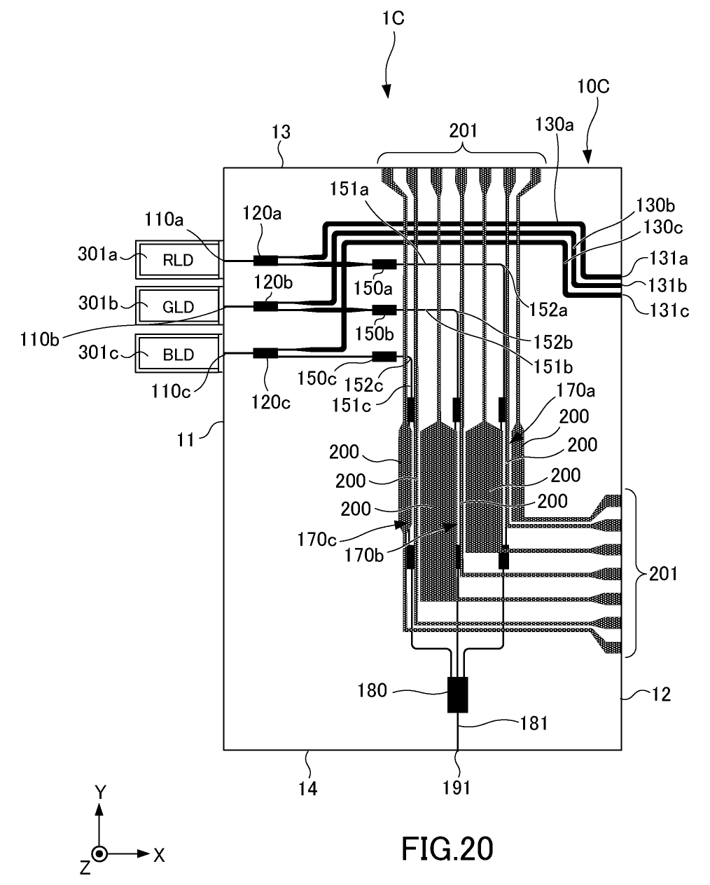

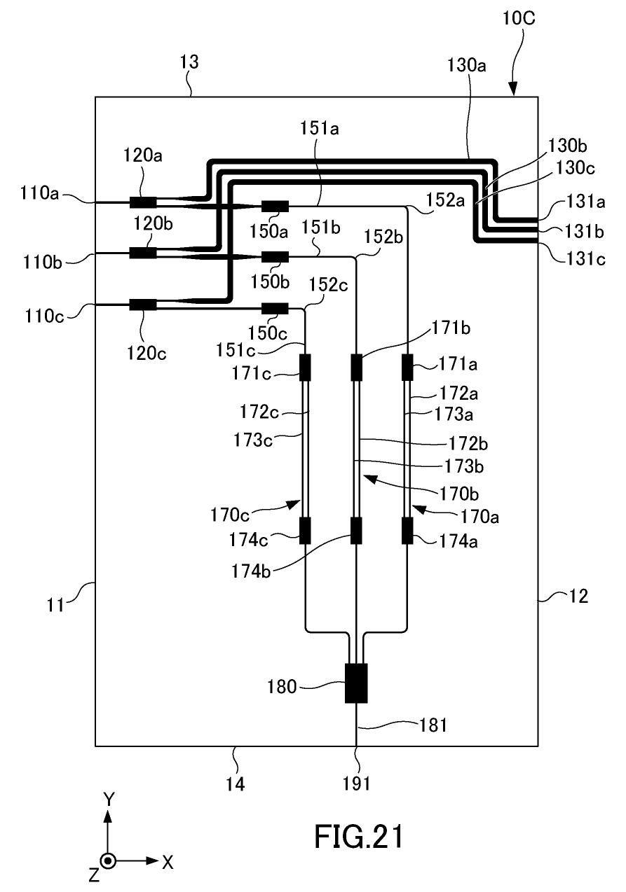

A third embodiment of the present disclosure will be described. FIG. 20 is a schematic plan view of the light source module 1C in this embodiment. FIG. 21 is a schematic plan view showing the state in which the electrode 200 and the pad portion 201 are removed from the light source module 1C in FIG. 20. In the third embodiment, the same components as those in the first and second embodiments are given the same reference numerals, and the description will be omitted as appropriate.

The light source module 1C in the third embodiment has an optical device 10C. The optical device 10C differs from the optical device 10A in the first embodiment in that the modulation optical waveguides 151a, 151b, and 151c are bent substantially vertically at the bending portions 152a, 152b, and 152c.

As shown in FIGS. 20 and 21, the modulation optical waveguide 151a is bent substantially vertically at the bent portion 152a disposed between the high-order mode filter 150a and the optical modulation portion 170a. The branching waveguides 172a and 173a constituting the optical modulation portion 170a extend in the Y direction. Similarly, the modulation optical waveguide 151b is bent substantially vertically at the bent portion 152b disposed between the high-order mode filter 150b and the optical modulation portion 170b. The branching waveguides 172b and 173b constituting the optical modulation portion 170b extend in the Y direction. Similarly, the modulation optical waveguide 151c is bent substantially vertically at the bent portion 152c disposed between the high-order mode filter 150c and the optical modulation portion 170c. The branching waveguides 172c and 173c constituting the optical modulation portion 170c extend in the Y direction.

The output optical waveguide 181 connected to the optical multiplexing portion 180 extends linearly in the Y direction and is connected to an optical output port 191 disposed on the fourth end face 14.

In this embodiment, by increasing the length of the optical device 10C in the Y direction, it is possible to ensure a sufficient length for the branching waveguides 172a, 173a, 172b, 173b, 172c, and 173c to modulate light. On the other hand, it is possible to shorten the length of the optical device 10C in the X direction.

The monitor optical waveguides 130a, 130b, and 130c are connected to the monitor ports 131a, 131b, and 131c disposed on the second end face 12, and extend in the light incidence direction (X direction) of the optical input ports 110a, 110b, and 110c. By shortening the length of the optical device 10B in the X direction, the monitor optical waveguides 130a, 130b, and 130c can be shortened, thereby making it possible to reduce the propagation loss of the monitoring light.

The light source module 1C in the third embodiment can perform active alignment in the same manner as the first embodiment. It is also possible to dispose an anti-reflection device 320 and to incorporate the light source module 1C into the optical system 500.

### Fourth embodiment

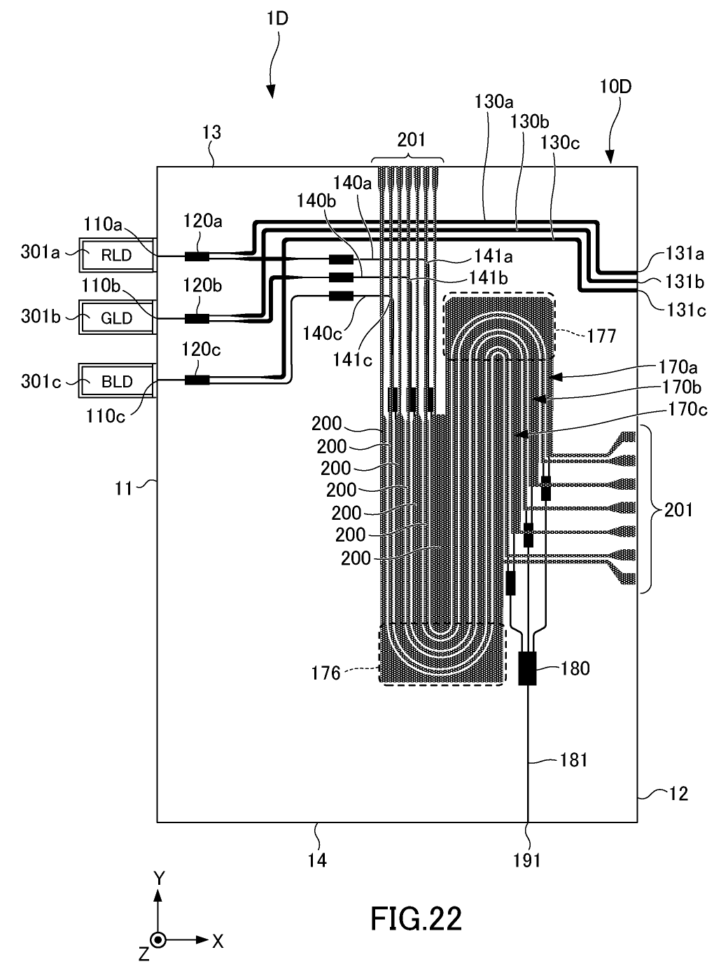

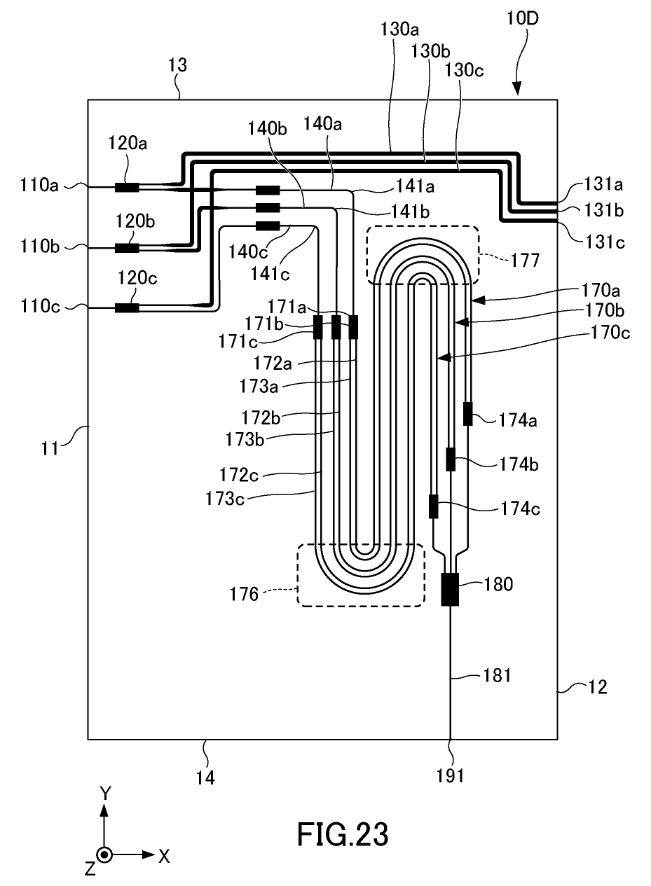

The fourth embodiment of the present disclosure will be described. FIG. 22 is a schematic plan view of the light source module 1D in this embodiment. FIG. 23 is a schematic plan view showing the state in which the electrode 200 and the pad portion 201 are removed from the light source module 1D in FIG. 22. In the fourth embodiment, the same components as those in the third embodiment are given the same reference numerals, and the description will be omitted as appropriate.

The light source module 1D in the fourth embodiment has an optical device 10D. The optical device 10D differs from the optical device 10C in the third embodiment in that the Mach-Zehnder type optical waveguides constituting the optical modulation portions 170a, 170b, and 170c are configured by folded optical waveguides. Further, in the optical device 10D, the modulation optical waveguides 140a, 140b, and 140c are bent substantially vertically at the bent portions 141a, 141b, and 141c, but they may be bent at the modulation optical waveguides 151a, 151b, and 151c, as in the optical device 10C. Furthermore, the electrode 200 of the optical device 10D has a shape suited to the folded optical waveguides.

As shown in FIGS. 22 and 23, the branching waveguides 172a and 173a constituting the optical modulation portion 170a have folded portions 176 and 177 that invert the light propagation direction. The branching waveguides 172a and 173a are curved in a U-shape at the two folded portions 176 and 177. Except for the folded portions 176 and 177, the branching waveguides 172a and 173a are linear and extend parallel to the Y direction. Similarly, the branching waveguides 172b and 173b constituting the optical modulation portion 170b and the branching waveguides 172c and 173c constituting the optical modulation portion 170c are also curved in a U-shape at the folded portions 176 and 177.

By adopting the folded type of optical waveguides for the optical modulation portions 170a, 170b, and 170c, the length of the optical device 10D in the light incidence direction of the optical input ports 110a, 110b, and 110c (length in the X direction) can be shortened. As a result, the entire optical device 10D can be further made smaller.

In addition, the monitor optical waveguides 130a, 130b, and 130c are connected to the monitor ports 131a, 131b, and 131c disposed on the second end face 12, and extend in the light incidence direction (X direction) of the optical input ports 110a, 110b, and 110c. By shortening the length of the optical device 10D in the X direction, the monitor optical waveguides 130a, 130b, and 130c can be shortened, thereby making it possible to reduce the propagation loss of the monitoring light.

Furthermore, by adopting the folded type of optical waveguide, the length of the branching waveguides 172a, 173a, 172b, 173b, 172c, and 173c to which an electric field is applied can be sufficiently ensured. As a result, the drive voltage required for modulating the display light can be reduced, thereby making it possible to reduce the power consumption of the entire optical device 10D.

The light source module 1D in the fourth embodiment can perform active alignment as in the first embodiment. It is also possible to dispose an anti-reflection device 320 and to incorporate the light source module 1D into the optical system 500.

Although each embodiment of the present disclosure has been described, the present disclosure is not limited to each embodiment. Various modifications and changes are possible within the scope of the spirit of the present disclosure, and each embodiment can also be appropriately combined.

As described above, the present disclosure has the effect of stably obtaining a sufficient amount of monitoring light from a monitor port, and is useful in optical device technology using visible light in general, and in XR glasses that project image display light in particular.

Although the disclosure has been described with respect to only a limited number of embodiments, those skilled in the art, having benefit of this disclosure, will appreciate that various other embodiments may be devised without departing from the spirit and scope of the present disclosure. Accordingly, the technical scope of the disclosed subject matter should be limited only by the attached claims.

### Description of Reference Numerals and Signs

1A, 1B, 1C, 1D, 510 Light source module

10A, 10B, 10C, 10D Optical device

11 First end face

12 Second end face

13 Third end face

14 Fourth end face

101 Substrate

102 Optical function layer

103 Optical waveguide layer

103a Slab layer

103b, 103b1, 103b2, 103b3 Ridge portion

104 First buffer layer

105 Second buffer layer

106 Protective layer

106a End

110a, 110b, 110c Optical input port

111a, 111b, 111c Input optical waveguide

120a, 120b, 120c, 171a, 171b, 171c Optical branching part

130a, 130b, 130c Monitor optical waveguide

131a, 131b, 131c monitor port

135a, 135b, 135c, 161a, 161c, 162b, 162c, 163a, 163b, 163c, 164a, 164b, 164c taper part

135a1, 161c1, 162c2, 163c1, 164c2 Narrow end

135a2, 161c2, 162c1, 163c2, 164c1 Wide end

135a3, 161c3, 163c3 Widened part

140a, 140b, 140c, 151a, 151b, 151c, 175a, 175b, 175c Modulation optical waveguide

141a, 141b, 141c, 152a, 152b, 152c, 182 Bending portion

150a, 150b, 150c High-order mode filter

150a1 Curved waveguide

150a2, 150a3 Curved portion

160a, 160b, 160c Crossing waveguide

162c3, 164c3 Narrowing portion

165a, 165b, 165c Cruciform portion

166 Connecting portion

170a, 170b, 170c Optical modulation portion

172a, 172b, 172c, 173a, 173b, 173c Branching waveguide

174a, 174b, 174c, 180 Optical multiplexing portion

176, 177 Folding portion

181 Output optical waveguide

191 Optical output port

200 Electrode

200G Reference electrode

200S Drive electrode

201 Pad portion

201a Upper surface

301a, 301b, 301c Visible laser light source

302a, 302b, 302c Subcarrier

303a, 303b, 303c Junction portion

310 Optical detection device

320 Anti-reflection device

500 Optical system

520 Optical assembly

521 Collimator lens

522 Slit

523 ND filter

524 Optical scanning mirror

530 Laser driver

540 Optical scanning mirror driver

550 Video controller

600 XR glasses

601 Frame

602 Lens

LE Emitted light

What is claimed is:

1. An optical device comprising:
a substrate; and
an optical function layer formed on a main surface of the substrate,
wherein the optical function layer comprises:
optical input ports respectively corresponding to a plurality of visible laser light sources and capable of receiving visible light emitted from the corresponding visible laser light source;
input optical waveguides respectively connected to the optical input ports;
optical branching portions respectively having an input portion connected to each input optical waveguide and two output portions;
monitor optical waveguides respectively connected to one of the output portions of each optical branching portion;
monitor ports respectively connected to the monitor optical waveguides and emitting monitoring light to the outside;
first optical waveguides respectively connected to the other of the output portions of each optical branching portion;
optical modulation portions respectively connected to the first optical waveguides;
second optical waveguides respectively connected to the optical modulation portions;
an optical multiplexing portion connected to the second optical waveguides;
an output optical waveguide connected to the optical multiplexing portion; and
an optical output port connected to the output optical waveguide and emitting light multiplexed by the optical multiplexing portion to the outside.

2. The optical device according to claim 1, wherein the width of the monitor optical waveguide is wider than the width of the optical waveguide constituting the optical modulation portion.

3. The optical device according to claim 2, further comprising a tapered portion configured to expand the width of the monitor optical waveguide.

4. The optical device according to claim 1, further comprising a crossing waveguide at an intersection portion of the monitor optical waveguide and the first optical waveguide.

5. The optical device according to claim 4, wherein the crossing waveguide includes a cruciform portion located at the intersection center, and a tapered portion that expands the width of the monitor optical waveguide or the first optical waveguide toward the cruciform portion.

6. The optical device according to claim 4, wherein the first optical waveguide crosses a plurality of the monitor optical waveguides, and crossing waveguides respectively disposed at a plurality of the intersection portions are connected to each other by a connecting portion.

7. The optical device according to claim 4, further comprising a high-order mode filter that removes light of a high-order mode between the crossing waveguide and the optical modulation portion.

8. The optical device according to claim 7, wherein the high-order mode filter includes a curved waveguide that is curved at a predetermined curvature.

9. The optical device according to claim 1, wherein the plurality of visible laser light sources emit visible light having mutually different wavelengths, and a curvature of the curved waveguide is individually set according to the wavelength of the visible light.

10. The optical device according to claim 9, the visible light includes red light , green light, and blue light, the radius of curvature of the curved waveguide corresponding to the red light being 40 μm to 80 μm, the radius of curvature of the curved waveguide corresponding to the green light being 60 μm to 100 μm, and the radius of curvature of the curved waveguide corresponding to the blue light being 100 μm to 140 μm.

11. The optical device according to claim 1, further comprising a protective layer on an upper surface of the optical function layer,
wherein a part of a pad portion electrically connected to an electrode of the optical modulation portion is exposed to the outside without being covered by the protective layer.

12. The optical device according to claim 1, wherein the optical waveguide constituting the optical modulation portion includes a folded portion that inverts the light propagation direction.

13. The optical device according to claim 1, wherein at least a part of the optical waveguide constituting the optical modulation portion is formed in a direction perpendicular to the light incidence direction of the optical input port.

14. A light source module comprising the optical device according to claim 1, and the plurality of visible laser light sources.

15. The light source module according to claim 14, wherein the plurality of visible laser light sources respectively emit red, green, and blue visible light.

16. The light source module according to claim 14, further comprising an anti-reflection device configured to attenuate or scatter the monitoring light emitted from the monitor port.

17. The light source module according to claim 16, wherein the anti-reflection device is detachably mounted on the monitor port.

18. A method for manufacturing the light source module according to claim 11, comprising:
directing visible light emitted from the visible laser light source into the light input port;
directing output light emitted from the monitor port into an optical detection device;
adjusting a relative position of the visible laser light source with respect to the optical device, based on a detection result of the optical detection device; and
fixing the visible laser light source to the optical device at a position where an optical axis of the visible light emitted from the visible laser light source coincides with a center position of the light input port.

19. An optical engine comprising the light source module according to claim 14; and an optical scanning mirror that reflects the light emitted from the light source module at a different angle so as to display an image.

20. XR glasses comprising the optical engine according to claim 19.
